(19) United States
(12) Patent Application Publication
(10) Pub. No.: US 2025/0392898 A1
(43) Pub. Date: Dec. 25, 2025

(54) SYSTEM AND METHOD FOR PROVIDING A POLICY CONTROL FUNCTION IN A NETWORK

(71) Applicant: JIO PLATFORMS LIMITED, Ahmedabad (IN)

(72) Inventors: Aayush BHATNAGAR, Navi Mumbai (IN); Mukta SHETTY, Maharashtra, Thane (IN); Kunuguntla ANJALI, Vatsavai Mandal (IN); Gaurav NARAYAN, Jharkhand, Ranchi (IN); Sayali Bhaskar JADHAV, Nashik (IN)

(73) Assignee: JIO PLATFORMS LIMITED, Ahmedabad (IN)

(21) Appl. No.: 18/880,382

(22) PCT Filed: Jan. 30, 2024
(86) PCT No.: PCT/IN2024/050084

§ 371 Date: Dec. 31, 2024

(30) Foreign Application Priority Data
Jan. 31, 2023 (IN) 202321006380

(51) Int. Cl. H04W 8/08; H04L 67/02; H04L 67/306; H04W 60/00

(52) U.S. Cl. CPC H04W 8/08; H04L 67/02; H04L 67/306; H04W 60/00

(57) ABSTRACT

A policy control function (PCF) to provide a plurality of policy rules for control plane functions of a network is disclosed. The PCF is configured to receive, by an access management function (AMF), at least one registration request message from at least one terminal device. The PCF is further configured to selecting, by the AMF, a PCF currently serving the at least one terminal device based on the received at least one registration request. The PCF is further configured to retrieve, from a subscriber profile repository (SPR), at least one subscriber's profile associated with the at least one terminal device. The PCF is further configured to create at least one policy rule for the subscriber in real-time based on the at least one subscriber's profile. The PCF is further configured to send, to the AMF, a response message comprising the at least one created policy rule.

### RESERVATION OF RIGHTS

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless networks, and specifically to a system and a method for providing an advanced Policy Control Function (PCF).

### Definition

As used in the present disclosure, the following terms are generally intended to have the meaning as set forth below, except to the extent that the context in which they are used to indicate otherwise.

The term LADN as used herein, refers to Local Area Data Network. The LADN is a feature in 5G networks that allows a local operator or enterprise to provide data services within a limited geographic area, such as a building, campus, or industrial site.

The term SUPI as used herein, refers to subscription permanent identifier.

The term NSSAI as used herein, refers to network slice selection assistance information.

The term RFSP index as used herein, refers to RAT frequency selection priority (RFSP) index.

The term SPR as used herein, refers to subscriber profile repository.

The term FCAP as used herein, refers to a fault, configuration, accounting, performance (FCAP) manager.

The term GPSI as used herein, refers to generic public subscription identifier.

The term SDL as used herein, refers to session database layer.

The term SMSC as used herein, refers to a short message service center.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Typically, a network service provider may monitor various parameters related to performance of a wireless network. For example, the network service providers may monitor bandwidth utilization, packet drop and packet transfer statistics, initial connection time wait, and network loss. The performance parameters may be monitored and recorded in performance metrics. The network service provider may identify network problems and identify functional aspects of the wireless network that may need improvisation. Present available mechanisms are inefficient in adequately identifying and resolving network problems.

There is, therefore, a need in the art for an improved system and method that effectively provides a Policy Control Function (PCF) that efficiently manages functioning of the wireless network.

### SUMMARY

In an exemplary embodiment, the present invention discloses a policy control function (PCF) to provide a plurality of policy rules for control plane functions in a network. The PCF is configured to receive, by an access management function (AMF), at least one registration request message from at least one terminal device. The PCF is configured to select, by the AMF, a PCF currently serving the at least one terminal device based on the received at least one registration request. The PCF is configured to create at least one policy rule for a subscriber in real-time based on at least one subscriber's profile and a plurality of parameters and send, to the AMF, a response message comprising the at least one created policy rule.

In some embodiments, the plurality of parameters comprises one or more of: subscription permanent identifier (SUPI), network slice selection assistance information (NSSAI), service area restrictions, RAT frequency selection priority (RFSP) index, generic public subscription identifier (GPSI), and a list of internal group identifiers.

In some embodiments, the at least one subscriber's profile associated with the at least one terminal device is retrieved from a subscriber profile repository (SPR).

In some embodiments, the PCF comprising a system management point (SMP), a fault, configuration, accounting, performance (FCAP) manager, an availability (HA) state manager, a session database layer (SDL) and the SPR.

In some embodiments, the PCF is further configured to integrate with a plurality of network functions via a service communication proxy (SCP) using a hypertext transfer protocol 2 (HTTP2) based interface.

In some embodiments, the at least one policy includes a plurality of service area restrictions, a RAT frequency selection priority (RFSP) index, at least one policy control request trigger condition and a related policy.

In some embodiments, the AMF deploys the at least one policy rule to the at least one terminal device and provision the RFSP index and the plurality of service area restrictions to the network.

In some embodiments, during relocation of the AMF, the PCF is selected based on a PCF ID received by a new AMF from a source AMF.

In some embodiments, the created at least policy rule is based on a specific domain name network (DNN) and a policy rule engine.

In an exemplary embodiment, the present invention discloses a network comprising a policy control function (PCF) to provide a plurality of policy rules for control plane functions in the network. The PCF is configured to receive, by an access management function (AMF), at least one registration request message from at least one terminal device. The PCF is configured to select, by the AMF, a PCF currently serving the at least one terminal device based on the received at least one registration request. The PCF is configured to create at least one policy rule for a subscriber in real-time based on at least one subscriber's profile and a plurality of parameters and send, to the AMF, a response message comprising the at least one created policy rule.

In an exemplary embodiment, the present invention discloses a method for providing a plurality of policy rules for control plane functions in a network comprising a policy control function (PCF). The method comprising receiving, by an access management function (AMF), at least one registration request message from at least one terminal device. The method comprising selecting, by the AMF, a PCF currently serving the at least one terminal device based on the received at least one registration request. The method comprising creating at least one policy rule for a subscriber in real-time based on at least one subscriber's profile and a plurality of parameters and sending, to the AMF, a response message comprising the at least one created policy rule.

In some embodiments, the plurality of parameters comprises one or more of: subscription permanent identifier (SUPI), network slice selection assistance information (NSSAI), service area restrictions, RAT frequency selection priority (RFSP) index, generic public subscription identifier (GPSI), and a list of internal group identifiers.

In some embodiments, the at least one subscriber's profile associated with the at least one terminal device is retrieved from a subscriber profile repository (SPR).

In some embodiments, the PCF comprising a system management point (SMP), a fault, configuration, accounting, performance (FCAP) manager, an availability (HA) state manager, a session database layer (SDL) and the SPR.

In some embodiments, the PCF is further configured to integrate with a plurality of network functions via a service communication proxy (SCP) using a hypertext transfer protocol 2 (HTTP2) based interface.

In some embodiments, the at least one policy includes a plurality of service area restrictions, a RAT frequency selection priority (RFSP) index, at least one policy control request trigger condition and a related policy.

In some embodiments, the AMF deploys the at least one policy rule to the at least one terminal device and provision the RFSP index and the plurality of service area restrictions to the network.

In some embodiments, during relocation of the AMF, the PCF is selected based on a PCF ID received by a new AMF from a source AMF.

In some embodiments, the created at least policy rule is based on a specific domain name network (DNN) and a policy rule engine.

The foregoing general description of the illustrative embodiments and the following detailed description thereof are merely exemplary aspects of the teachings of this disclosure and are not restrictive.

### OBJECTS OF THE PRESENT DISCLOSURE

It is an object of the present disclosure to provide a system and a method for providing an advanced Policy Control Function (PCF).

It is an object of the present disclosure to provide the PCF having policy rules for control plane functions.

It is an object of the present disclosure to provide the policy rules like network slicing, roaming and mobility management.

It is an object of the present disclosure to provide a PCF design having high resilience and scalability.

It is an object of the present disclosure to provide the PCF such that there is no single point of failure which includes node level redundancy, network redundancy and geo-redundancy.

It is an object of the present disclosure to provide minimal latency and packet loss under load condition in a wireless network.

It is an object of the present disclosure to integrate the PCF with other network functions via HyperText Transfer Protocol 2 (HTTP2) based interfaces both directly and via a Service Communication Proxy (SCP).

It is an object of the present disclosure to enable providing a separate Session Database Layer (SDL) to provide session data across multiple sites for geo-redundancy.

It is an object of the present disclosure to deploy the PCF in active, hot standby and spare manner across the wireless network.

It is an object of the present disclosure to enable load distribution of messages by the SCP on multiple PCF blades based on subscriber's identities i.e., Subscription Permanent Identifier (SUPI) ranges.

It is an object of the present disclosure to enable providing a separate SDL that provides session data across sites for geo-redundancy.

It is an object of the present disclosure to provide an embedded Subscription Profile Repository (SPR) with the PCF.

It is an object of the present disclosure to provide a centralized health checkfunctionality.

It is an object of the present disclosure to provide overload control mechanisms for stable functioning during sudden bursts of traffic.

It is an object of the present disclosure to integrate policy related aspects in the network.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an internal cluster architecture of a Policy Control Function (PCF) design, in accordance with an embodiment of the present disclosure.

FIG. 2 illustrates an exemplary implementation of the PCF deployed in super core locations, in accordance with an embodiment of the present disclosure.

FIG. 3 illustrates a call flow for UE registration with 5G Core Network (CN), in accordance with an embodiment of the present disclosure.

FIG. 4 illustrates AM Policy and UE policy establishment flows, in accordance with an embodiment of the present disclosure.

FIG. 5 illustrates UE policy association establishment flows, in accordance with an embodiment of the present disclosure.

FIG. 6 illustrates PDU session establishment flows, in accordance with an embodiment of the present disclosure.

FIG. 7 illustrates SM policy association establishment flows, in accordance with an embodiment of the present disclosure.

FIG. 8 illustrates PDU session modification flows, in accordance with an embodiment of the present disclosure.

FIG. 9 illustrates PCF initiated session modification flows, in accordance with an embodiment of the present disclosure.

FIG. 10 illustrates SMF initiated session modification flows, in accordance with an embodiment of the present disclosure.

FIG. 11 illustrates PDU session termination flows, in accordance with an embodiment of the present disclosure.

FIG. 12 illustrates SMF initiated SM policy association termination flows, in accordance with an embodiment of the present disclosure.

FIG. 13 illustrates a NF registration for registering an NF instance in NRF, in accordance with an embodiment of the present disclosure.

FIG. 14 illustrates a NF update involving complete replacement, in accordance with an embodiment of the present disclosure.

FIG. 15 illustrates a NF update involving partial replacement, in accordance with an embodiment of the present disclosure.

FIG. 16 illustrates a NF Heart-Beat, in accordance with an embodiment of the present disclosure.

FIG. 17 illustrates a NRF NFderegister, in accordance with an embodiment of the present disclosure.

FIG. 18 illustrates a NF AccessToken request, in accordance with an embodiment of the present disclosure.

FIG. 19 illustrates a NF StatusSubscribe, in accordance with an embodiment of the present disclosure.

FIG. 20 illustrates a NF StatusUnSubscribe, in accordance with an embodiment of the present disclosure.

FIG. 21 illustrates a NF Status Notify, in accordance with an embodiment of the present disclosure.

FIG. 22 illustrates a NF Discovery Request, in accordance with an embodiment of the present disclosure.

FIG. 23 illustrates an exemplary computer system in which or with which embodiments of the present disclosure may be implemented.

### LIST OF REFERENCE NUMERALS

100—An internal cluster architecture of a Policy Control Function (PCF) design
200—An exemplary implementation of the PCF deployed in super core
locations 300—Flow diagram
400—Flowdiagram
500—Flowdiagram
600—Flowdiagram
700—Flowdiagram
800—Flowdiagram
900—Flowdiagram
1000—Flowdiagram
1100—Flowdiagram
1200—Flowdiagram
1300—Flowdiagram
1400—Flowdiagram
1500—Flowdiagram
1600—Flowdiagram
1700—Flowdiagram
1800—Flowdiagram
1900—Flowdiagram
2000—Flowdiagram
2100—Flowdiagram
2200—Flow diagram
2300—A computer system
2310—Bus
2320—Processing unit
2330—Main memory
2340—Read only memory (ROM)
2350—Storage device
2360—Input device
2370—Output device
2380—Communication interface

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The disclosed system and method provides an advanced architecture to provide a Policy Control Function (PCF) in a core network that further provides a network agnostic solution (wireline and wireless) and enables providing a multi-dimensional approach which helps in creating a lucrative and innovative platform for operators.

The PCF may be integrated with different platforms like billing, rating, charging, and subscriber database or deployed as a standalone entity. The PCF provides policy rules for control plane functions. This includes network slicing, roaming and mobility management. Accesses subscription information for policy decisions taken by Subscription Profile Repository (SPR). It supports new 5G quality of service (QOS) policy and charging control function. It manages policies, services, subscriptions, quotas, and bearer resources.

The PCF provides a network agnostic solution (e.g., wireline and wireless) and enables providing a multi-dimensional approach which helps in creating a lucrative and innovative platform for operators. The PCF may be integrated with different platforms like billing, rating, charging, and subscriber database or deployed as a standalone entity. The PCF provides policy rules for control plane functions. This includes network slicing, roaming and mobility management, accesses subscription information for policy decisions taken by the SPR. Further, the PCF supports new 5G quality of service (QOS) policy and charging control functions which enables managing policies, services, subscriptions, quotas, and bearer resources.

The policies may be created in real-time based on a subscriber profile provided by Subscriber Profile Repository (SPR). The SPR is a logical entity containing all the subscription related information needed for subscription-based policies. The SPR is an integrated part of the PCF.

The PCF solution to function depends on the following components:
PCF System Management Point (Service Management Point (SMP))
Fault, Configuration, Accounting, Performance (FCAP) manager
High Availability State Manager (HSM) (HA State manager)
SDL (Session Database Layer)
SPR (Subscriber Profile Repository)

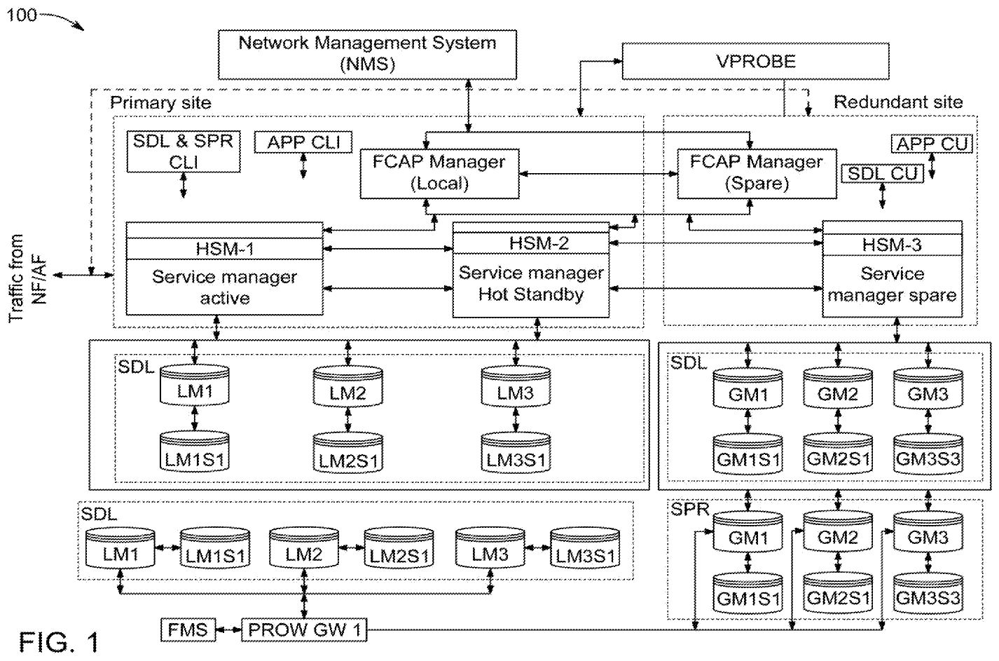

FIG. 1 illustrates an internal cluster architecture 100 of a Policy Control Function (PCF) design, in accordance with an embodiment of the present disclosure. The illustrated PCF design (a) has high resilience and is scalable, (b) has no single point of failure which includes node level redundancy, network redundancy as well as geo-redundancy, (c) has minimal latency and packet loss under load condition, (d) enables the PCF to integrate with other network functions for HyperText Transfer Protocol2 (HTTP2) based interfaces both directly as well as via Service Communication Proxy (SCP), (e) separates Session Database Layer (SDL) to provide session data across multiple sites for geo-redundancy, (f) may be deployed in an active, hot standby and spare manner, (g) provides load distribution of messages by the SCP on multiple PCF blades based on subscriber's identities i.e., SUPI ranges, (h) has a separate SDL that provides session data across sites for geo-redundancy, (i) embedded the SPR with the PCF, (j) can be deployed in active, hot standby and spare manner, (k) provides a centralized health check functionality, and (l) provides overload control mechanisms for stable functioning during sudden burst of traffic.

Described below in further sections are each of components of the architecture:

One of the component is a Service Manager (SM).

The Service Manager (SM) is a main application that serves received requests. The SM is deployed in an active/standby/spare architecture as mentioned below:
The SM active is the application that serves requests in a local site.
The SM hot standby is the standby application that becomes active when a currently running active instance goes down.
The SM spare is the application that runs on a geographical redundant site which becomes active when both the applications running in the local site goes down.

One of main purposes of the SM application are (a) to handle the HTTP2/diameter signalling traffic to/from peer NFs, (b) integration with Fault, Configuration, Accounting, Performance (FCAP) manager application for Network Management System (NMS)/Element Management System (EMS) related functions, (c) connectivity with Session Database Layer (SDL) for storing and retrieving the NF specific data, (d) interconnectivity with vProbe for transfer of Streaming Data Records (SDR), and (e) provide the Service Management Point (SMP) to serve as Graphical User Interface (GUI) for the NF.

Another component of the architecture is a FCAP manager. The FCAP manager is a micro service that is responsible for providing fault, configuration, accounting and performance management services. This Operation and Management micro service is also responsible for interacting with the NMS.

Another component of the architecture is the SDL. The SDL provides a data node functionality which as the name suggests is used to store session data in a persistent database. The SDL is divided into two sub components-a SDL master node and a SDL slave node. The SDL master node is responsible for handling requests for cache from the application. This acts as a level 2 cache for failover. Further, the SDL slave node saves a replicated copy of write requests and handles read requests.

Another component of the architecture is Provisioning Gateway (ProvGW) that is used by the PCF for provisioning of subscriber profile data into the SPR. The provisioning gateway is integrated with Fulfilment Management System (FMS) as a northbound interface. The FMS pushes the subscriber profile data relevant to the PCF towards provisioning gateway, which in turn provisions the SPR. The PCF fetches the subscriber profile from the SPR.

Another component is Subscriber Profile Repository (SPR) that provides a data node functionality, which is used to store the subscriber profile provisioned by the Provisioning Gateway (ProvGW) in a persistent database. If the PCF does not have the subscription data for the SUPI and DNN in its cache, it queries the SPR database for the subscription data. The SPR is divided into two sub components:
SPR master node will be responsible for handling requests from the application.
SPR slave node will save replicated copy of write requests and handle read requests.

Another component of the architecture is a High Availability State Manager (HSM) that is responsible for handling fault tolerance of the cluster. This application collocates with a SM application container. The HSM dictates the active/standby/spare role to be taken by the SM application.

Another component of the architecture is a Command Line Interface (CLI). The disclosed system provides a separate CLI for managing the application and the SDL. An application CLI manages a command line interface or Multi-modal Markup Language (MML) that is responsible for managing the application. Further, a SDL CLI provides a command line interface for fetching statistics of a session data layer.

In an embodiment are disclosed features and functions for the NF.

TABLE 1
Shows the NRF service used by the PCF.

| Service Operations | Description |
|---|---|
| NFManagement_NFRegister | It allows an NF Instance to register its NF |
| | profile in the NRF. It includes the |
| | registration of the general parameters of |
| | the NF Instance, together with the list of |
| | services exposed by the NF Instance. |
| NFManagement_NFDeregister | It allows NF Instance to deregister its |
| | profile in the NRF, including the services |
| | offered by the NF Instance |
| NFManagement_NFUpdate (Including | It allows a PCF Instance to update NF |
| Heartbeat) | profile of NF Instance previously |
| | registered in NRF. Further, each NF that |
| | has previously registered in NRF shall |
| | contact the NRF periodically (heart-beat), |
| | by invoking the NF Update service |
| | operation, in order to show that the NF is |
| | still operative. |
| NFManagement_NFStatusSubscribe | It allows a PCF Instance to subscribe to |
| (Including Update) | changes on the status of NF Instances |
| | registered in NRF. Further, PCF Instance |
| | can also update subscription of PCF |
| | Instance previously subscribed in NRF |
| | using Update procedure for same. |
| NFManagement_NFStatusUnsubscribe | It allows a PCF Instance to delete |
| | subscription of PCF Instance previously |
| | subscribed in NRF. Unsubscribed |
| | instances will no longer receive |
| | StatusNotify. |
| NFManagement_NFStatusNotify | This service operation notifies each PCF |
| | Instance that was previously subscribed |
| | toreceive notifications of |
| | registration/deregistration |
| | Instances, or notifications of changes in |
| | the NF profile of a given NF Instance. |
| NFDiscovery_NFDiscover | This service operation discovers the set of |
| | NF Instances represented by their NF |
| | Profile of given NF type that are currently |
| | registered in NRF. |
| AccessToken_Get | For the authorized communication of PCF |
| | Instance with any other Node, PCF |
| | Instance may optionally send access |
| | token request to NRF with target details. |

The BSF services used by the PCF are discussed below:

TABLE 2
Shows the BSF service used by the PCF.

| Service Operations | Description |
|---|---|
| Management_Register | This Service Operation is used by PCF. |
| | This service operation is used to register |
| | the binding information for a UE when an |
| | IPv4 address and/or an IPV6 prefix is |
| | allocated for an IP PDU Session is used |
| | for an Ethernet PDU session. |
| Management_Deregister | This service operation is used by PCF. |
| | This service operation is used to |
| | deregister the binding information for a |
| | UE. |
| Management_Discovery | This service operation is used by a |
| | Consumer such as NEF or AF or |
| | NWDAF to discover a selected PCF |
| | for a UE |
| | Binding. This service operation is not used |
| | by PCF. |
| Management_Update | This service operation is used to update |
| | an existing session binding information |
| | for a UE (i.e. UE address(es) for a |
| | PDUSession). |

The CHF Services used by the PCF are discussed below:

TABLE 3
Shows the CHF services used by the PCF.

| Service Operations | Description |
|---|---|
| SpendingLimitControl_Subscribe | This service operation is used by an NF |
| | service consumer to subscribe to |
| | notification of changes in the status of the |
| | policy counters available and retrieval of |
| | the status of the policy counters for which |
| | subscription is accepted. |
| SpendingLimitControl_Unsubscribe | This service operation is used by an NF |
| | service consumer to unsubscribe from |
| | notification of changes in the status of all |
| | policy counters. |
| SpendingLimitControl_Notify | This service operation is used by the CHF |
| | to notify the NF service consumers (PCF) |
| | about the change of the status of the |
| | subscribed policy counters. |

The PCF provides support for following command codes for diameter based Rx interface and are discussed below:

TABLE 4
Shows Rx interfacemessages

| Command code | Description |
|---|---|
| AAR/AAA | This procedure is used between the |
| | AF/CSCF/BSF and PCF/PCRF to |
| | forward Session Information so as to |
| | govern the media related PCC policies. |
| RAR/RAA | This procedure is used between the |
| | PCF/PCRF and AF/CSCF/BSF in order |
| | to indicate Rx specific action. |
| STR/STA | Session Termination procedure is used |
| | between the AF/CSCF/BSF and |
| | PCF/PCRF to terminate the previously |
| | established Rx Session. |
| ASR/ASA | Abort Session procedure is used between |
| | the PCF/PCRF and AF/CSCF/BSF |
| | toinform that established session is no |
| | longer needed/available. |

The PCF provides support for following command codes for diameter Based Sdinterface.

TABLE 5
Shows Sd interfacemessages

| Command Code | Description |
|---|---|
| TSR/TSA | TDF Session procedure is used between |
| | the PCF/PCRF and TDF/DPI to establish |
| | TDF session and provision Application |
| | Detection Control rules and |
| | correspondingTriggers. |
| RAR/RAA | Re-Auth procedure is used between the |
| | PCF/PCRF and TDF/DPI in order to |
| | provision ADC rules using the PUSH |
| | procedure for application reporting and |
| | also provision triggers. This procedure |
| | may also be used by PCF/PCRF to |
| | request TDF Session Termination. |
| CCR/CCA (T) | CC-Request (Terminate) procedure is |
| | usedbetween TDF/DPI and PCF/PCRF in |
| | order for termination of Session using |
| | CCR-T. |

The PCF provides support to NBI systems (like FMS) for provisioning of subscriber profile in SPR via Provisioning Gateway (ProvGW). Further during SM/AM Session establishment procedure, PCF fetches the subscriber profile from SPR if not available in cache for the purpose of authenticating subscriber as well as provide policy rules based on subscriber profile.

The PCF supports communication via SCP. For communication with NRF, SCP controller is used. While that for communication with AMF or SMF or CHF-PC, SCP Proxy is used. Following Headers are added for supporting the SCP integration via SCP Proxy.

The PCF provides support for creating policy for SMF selection as defined for AM policy control.

The PCF provides support for Presence Reporting Area (PRA) feature. Based on this feature, change of UE presence in presence reporting area is informed to PCF based on which PCF may provide updated policies to consumer.

The PCF supports provisioning for UE-AMBR that limits aggregate bit rate that may be expected to be provided across all Non-GBR QOS Flows of a UE. Further, PCF provides the flexibility of providing the RFSP Index to AMF if requested. The same may be used by AMF for providing to an access network for applying specific radio resource management strategy.

The PCF provides a highly flexible and versatile rule engine for managing the AM Policy, SM Policy, Rx Rules and Sd Rules. It is provided in simple form where business rule may be created based on a user selected set of conditions and based on that selection of action which may include not only installation of PCC or Session Rules but other available flexibility like termination of session, rejecting the request and many more.

The PCF provides a special use case for handling the SIMODA subscribers. Please note that for Sim on demand activation (SIMODA) Subscriber range, SpendingLimitControl Service is not triggered by PCF. The PCF provides flexibility to not trigger the Sy session based on Custom Field as well.

The PCF enables SpendingLimitControl (Sy) Error Handling. The PCF provides handling for use cases where query towards CHF-PC for getting the Policy Counter IDs fail. In this case, the PCF may install the PCC Rule based on Error cause received from CHF-PC.

The PCF provides a user configurable TAI list for case of operations for barring/unbarring rules. The Business rule can contain TAI list Ids. Actual TACs in the list may be modified without modifying the business rule.

Special use case requirements for handling of subscriber SM Session for PLMN change based on PLMN values are included as part of Business Rule Engine. The user may check the ongoing call for subscribers and also decide to terminate the session once the call is over or immediately if needed.

The PCF reduces unnecessary sessions for the same subscriber. The PCF provides the feature to remove the duplicate PDU Sessions for the same subscriber created at the PCF.

The PCF provides emergency DNN support and handling of emergency cases as defined in standard.

The PCF installs a dynamic rule three times for all the 3 AARs received even when there is no change in subsequent AARs. With this feature, the PCF will send the AAA a success notification for subsequent AARs, where there is no change and will not trigger the SM update notify message towards SMF. By updating these Rx call flows, PCF will be able to decrease the TPS over SMF when no parameter is changed in Rx request The PCF will now send only modified values in dynamic rule of update notify request when Flow Status (Hold, Resume cases) and Media Type (downgrade, upgrade cases) is changed in the AAR. This will reduce the packet size significantly.

The PCF provides support for Non-3gpp access like WLAN and corresponding enhancements for n3galocation have been fulfilled in the PCF. The user can define the n3galocation fields as conditions in business rules based on requirement. This also includes 4G/5G Wi-Fi offload support.

The PCF supports an “EPSFallbackReport” feature. If the AF requests the PCF to report EPS fall-back, the AF shall subscribe to “EPS_FALLBACK” within the Specific-Action AVP. The AF shall request the PCF to report the EPS fall-back in conjunction with providing the PCF with the AF session information for voice media type. When the PCF receives the EPS fall-back indication from the SMF, the PCF will provide the corresponding EPS fall-back indication to the AF by sending an RAR. The RAR command will include the EPS_FALLBACK cause encoded in the Specific-Action AVP.

For very rare cases where the SPR is unavailable, the PCF has introduced a feature for SPR Bypass. In case SPR Bypass is triggered, the PCF shall use the global values for subscriber profile rather than doing the SPR dip for fetching the subscriber profile.

The PCF provides an advanced stale session handling for different interfaces. The users depending upon configuration may decide to remove the old/stale session without checking from peer nodes but may also decide to send a challenge and wait for a response based on which they decide to remove the old/stale session. Rate control for stale session challenges is also user configurable.

The PCF provides the overload control at both stack level as well as application level. For HTTP2 and Diameter Stack, user defined threshold limits are defined for managing the throttling of sudden bursts of traffic in the network. Further at application level, PCF provides user configurable queue threshold, which can be used for managing the overload created due to internal delays.

The PCF provides SMS delivery support for internet barring scenarios using the rule engine. The PCF will interact with short message service center (SMSC) Gateway Server over the SMPP interface.

The PCF will over-write old session or reject the new SMF/AMF session in case of duplicate create request with same SUPI, DNN, PDU Session Id and 3gpp-Sbi-Origination-Timestamp header combination. When the origination timestamp received in the create request is older than the current session timestamp then PCF will reject the request with error code 403 and cause LATE_OVERLAPPING_REQUEST. The PCF rejects an incoming request whose timestamp is less recent than the timestamp of the existing SM Policy Association with the Hypertext Transfer Protocol (HTTP) status code “403 Forbidden” and the application error “LATE_OVERLAPPING_REQUEST”.

The PCF Service Managers are deployed using the Active-Standby-Spare architecture to provide the high available cluster. High Availability State Manager (HSM) manages role assignment for Active Service Manager.

For ease of operations, the disclosed system supports automatic health check report generation using the health check commands in the CLI.

The disclosed system provides a vast array of counters for service operations supported by it, in addition to service operation based success and failure counters, additional counters for latency, NBI, Stack Counters.

The FCAP manager provides multiple alarms, which are based on system function as well as threshold-based alarms. These alarms are transferred to the NMS system for notification.

The disclosed system provides a capability to change log level for various functions of the NF. Like different log levels at application vs that at GUI/SMP vs that for replication vs configuration changes. Further, for error generated at system, integration with vProbe for sending SDR is supported as well.

The disclosed system provides configuration support via the SMP and via the CLI.

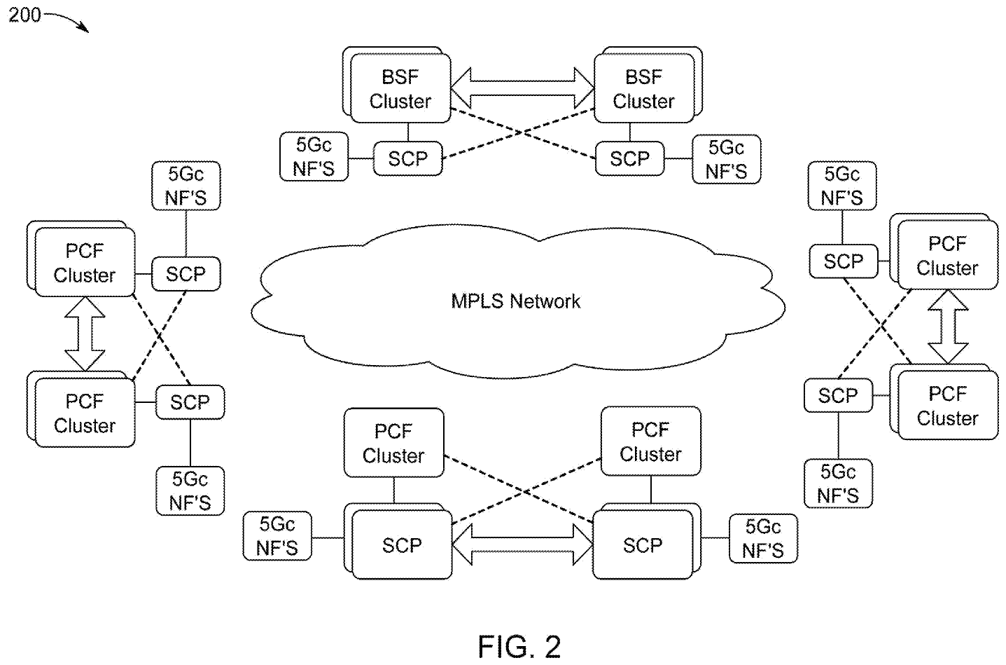

FIG. 2 illustrates an exemplary deployment architecture 200 of the PCF in the network, in accordance with an embodiment of the present disclosure. As illustrated, the PCF architecture is deployed in plurality locations in the network. All NFs deployed in the network shall connect with associated PCF in a Super Core using the SCP. Synchronization arrows between mated sites show a synchronization with local and geo service manager deployed at mated site, and not an interaction between different PCF clusters at different supercore locations.

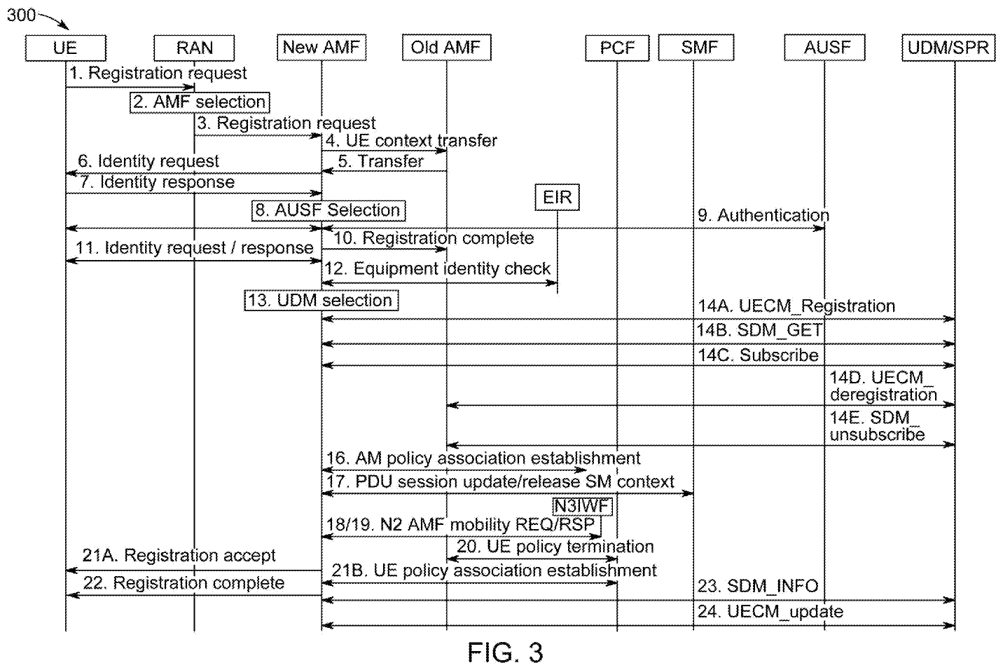

FIG. 3 illustrates a call flow 300 for UE (terminal device) registration with 5G Core Network (CN), in accordance with an embodiment of the present disclosure. End to end call flows for various use cases are captured. As illustrated is a call flow for UE Registration with the 5G CN. A UE needs to register with the network to get authorized to receive services, to enable mobility tracking and to enable reachability. The UE initiates the registration procedure using one of the following registration types:
Initial Registration to the 5G system;
Mobility Registration Update upon changing to a new Tracking Area (TA) outside the UE's Registration Area in both CM-CONNECTED and CM-IDLE state, or when the UE needs to update its capabilities or protocol parameters that are negotiated in Registration procedure with or without changing to a new TA; or when the UE intends to retrieve LADN Information; or
Periodic Registration Update (due to a predefined time period of inactivity)
Emergency Registration

Key steps related to the PCF are discussed below:
Step 15: PCF Selection Procedure-PCF may be selected on the following basis.
   PCF Selection using NRF.
   PCF Instance pre-configured in AMF.
   During AMF relocation, new AMF may receive PCF ID from source AMF.
Step 16: AM Policy Association Establishment for initial registration. This step may be further broken down as below:
   UE initial registration with the network.
   The AMF re-allocation with PCF change in handover procedure and registration procedure.
   UE registers with 5GS during the UE moving from EPS to 5GS when there is no existing AM Policy Association

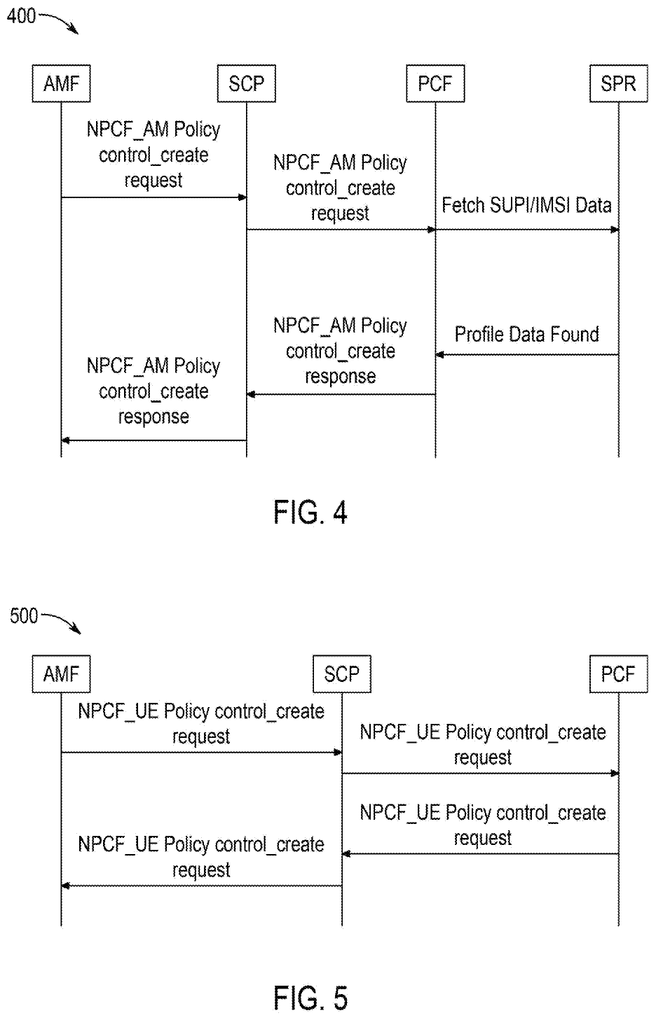

FIG. 4 illustrates AM Policy and UE policy establishment flows, in accordance with an embodiment of the present disclosure. In the non-roaming case the role of the V-PCF is performed by the PCF. For the roaming scenarios, the V-PCF interacts with the AMF (Step 2-step 3 are not executed in the roaming case). The V-PCF is a PCF in a Visited Public Land Mobile Network (VPLMN). The VPLMN is a PLMN upon which the mobile subscriber has roamed when leaving their HPLMN (Home Public Land Mobile Network).

Sub Step 1—The AMF receives the registration request from the AN. Based on local policy, the AMF selects to contact the (V-) PCF to create the policy association with the (V-) PCF and to retrieve Access and Mobility control policy. The AMF selects the PCF as described earlier and invokes the Npcf_AMPolicyControl_Create service operation by sending the HTTP POST request to the “AM Policy Associations” resource. The Npcf_AMPolicyControl_Create service operation is initiated by a network function (NF) service consumer (e.g. AMF). The Npcf_AMPolicyControl_Create service operation creates an AM policy association and provides corresponding policies to the NF service consumer. The request operation provides the SUPI and the allowed NSSAI if applicable, and if received from the UDM, the Service Area Restrictions, RESP index, GPSI and a list of Internal Group Identifiers, and may provide the access type, the PEI if received in the AMF, the User Location Information if available, the UE Time Zone if available, Serving Network, RAT type, globally unique AMF ID (GUAMI) of AMF, alternative or backup address(es) of AMF and trace control and configuration parameters information.

In an aspect, the internal group identifiers include other parameters like location and tracking area identity of the subscriber. Further, the service area restrictions include code assigned to specific area for specific services like barring etc.

The request includes a Notification URI to indicate to the PCF where to send a notification when the policy is updated.
Sub Step 2 to Step 3—If the PCF does not have the subscription data, it will connect with SPR to get subscription data for specific IMSI. SPR will provide the profile data to PCF.
Sub Step 4—The (V-) PCF makes the requested policy decision including Access and Mobility control policy information, and may determine applicable Policy Control RequestTrigger(s).
The (V) PCF sends an HTTP “201 Created” response to the AMF with the determined policies. The HTTP “201 Created” response describes that the policy association was created and policies are being provided to the AMF.
   Access and Mobility control Policy including Service Area Restrictions, and/or a RAT Frequency Selection Priority (RFSP) Index; and/or
   Policy Control Request Triggers and related policy information

The AMF deploys the Access and Mobility control policy information if received which includes storing the Service Area Restrictions, provisioning the Service Area Restrictions to the UE and/or provisioning the RFSP index and Service Area Restrictions to the NG-RAN.
Step 20: [Conditional] old AMF to Visited PCF: AMF-Initiated UE Policy Association Termination]—

If the old AMF previously initiated a UE Policy Association to the PCF, and the old AMF did not transfer the PCF ID(s) to the new AMF (e.g., new AMF is in different PLMN), the old AMF performs an AMF-initiated UE Policy Association Termination procedure.

If the old AMF transferred the PCF ID(s) in the UE context but the new AMF informed in step 10 that the UE Policy Association information in the UE context will not be used, then the old AMF performs an AMF-initiated UE Policy Association Termination procedure.
Step 21b: [Optional] The new AMF performs a UE Policy Association Establishment.

The procedure in the present sub-clause is applicable when the NF service consumer creates a UE policy association in the following cases:
UE initial registers to the network.
UE performs the mobility registration if the UE operating in the single-registration mode performs inter-system change from SI mode to NI mode and there is no existing UE Policy Association between AMF and PCF for this UE.
The AMF is relocated (between the different AMF sets) and the new AMF selects a new PCF. The procedure for the case where the AMF is relocated, and the new AMF selects the old PCF.
   The creation of an UE policy association only applies for normally registered UEs, i.e., it does not apply for emergency-registered UEs.

FIG. 5 illustrates UE policy association establishment flows 500, in accordance with an embodiment of the present disclosure. When a UE registers and a UE context is being established, if the AMF obtains from the UE a UE policy delivery protocol message, the AMF shall establish a UE policy association with the (V-) PCF in case that there is no existing UE policy association for the UE. Otherwise, the AMF may establish UE Policy Association with the (V-) PCF based on AMF local configuration such as that in case of Roaming.

To establish a UE policy association with the PCF, the NF service consumer (e.g. AMF) shall send an HTTP POST request with: “{apiRoot}/npcf-uc-policy-control/v1/policies/” as Resource URI and the Policy AssociationRequest data structure as request body that shall include notificationUri, SUPI and may also include optional attributes such as GPSI, accessType, PEI, userLoc, ratType, timeZone, servingPLMN, groupIDs, hPCFID, GUAMI etc. The PolicyAssociationRequest describes that the information that NF service consumer provides when requesting the creation of a policy association. The notificationUri identifies the recipient of notifications sent by the PCF.

Upon the reception of the HTTP POST request, UE shall assign UE policy association ID. PCF shall determine the applicable UE policy and provision towards AMF using Namf_Communication service. The Namf_Communication service enables an NF (e.g., AMF) to communicate with the UE through NI Non Access Stratum (NAS) messages or with the AN (both UE and non UE specific). The NI interface is used for NAS signaling including registration, connection management, session management, SMS, location services, etc. PCF shall subscribe at the AMF to notifications of NI messages for UE Policy Delivery Results using the Namf_Communication_NIN2MessageSubscribe service operation.

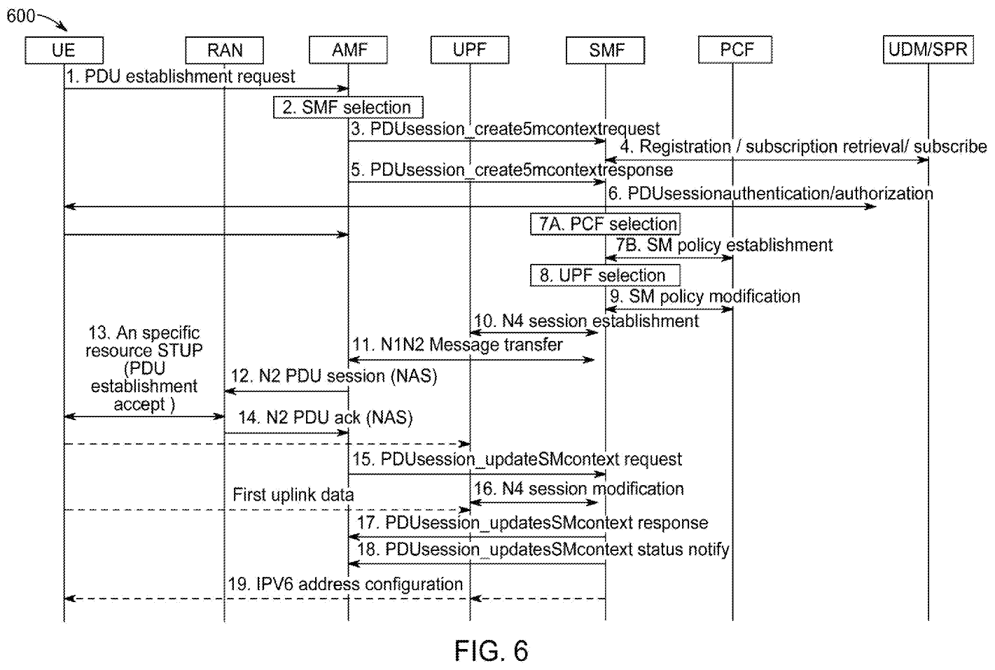

FIG. 6 illustrates PDU session establishment flows 600, in accordance with an embodiment of the present disclosure. The disclosed procedure below assumes that the UE has already registered on the AMF thus unless the UE is Emergency Registered the AMF has already retrieved the user subscription data from the UDM.

The PCF specific flows are discussed as below:
Step 7a: If dynamic PCC is to be used for the PDU Session, the SMF performs PCF selection. If the Request Type indicates “Existing PDU Session” or “Existing Emergency PDU Session,” the SMF shall use the PCF already selected for the PDU Session.
Step 7b: The SMF may perform an SM Policy Association Establishment procedure as defined to establish an SM Policy Association with the PCF and get the default PCC Rules for the PDUsession.

The main purpose of step 7 is to receive PCC rules before selecting UPF. If PCC rules are not needed as input for UPF selection, step 7 can be performed after step 8.

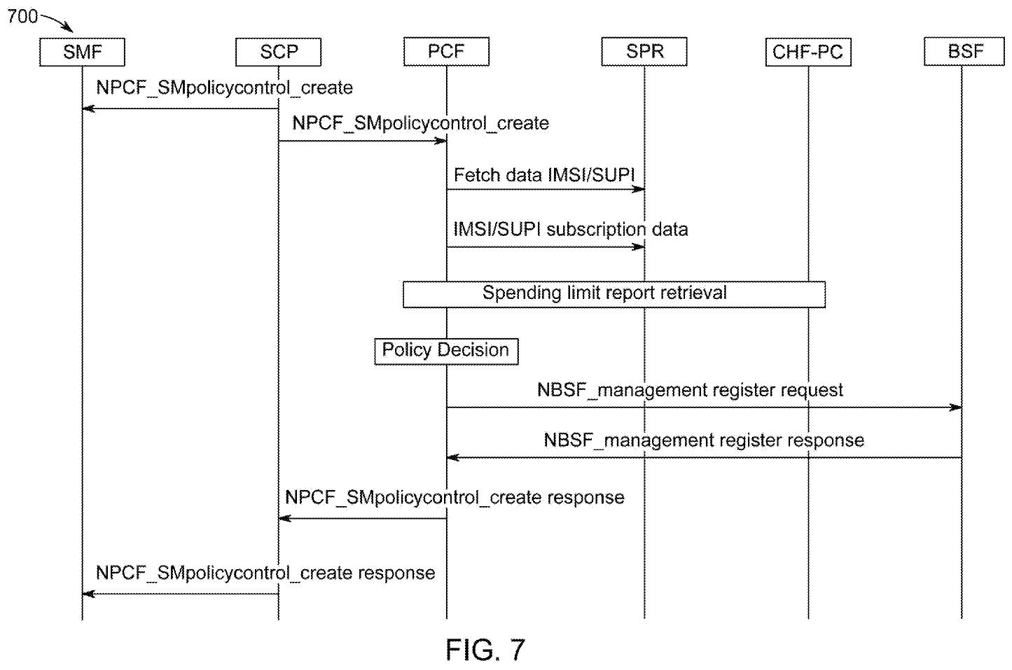

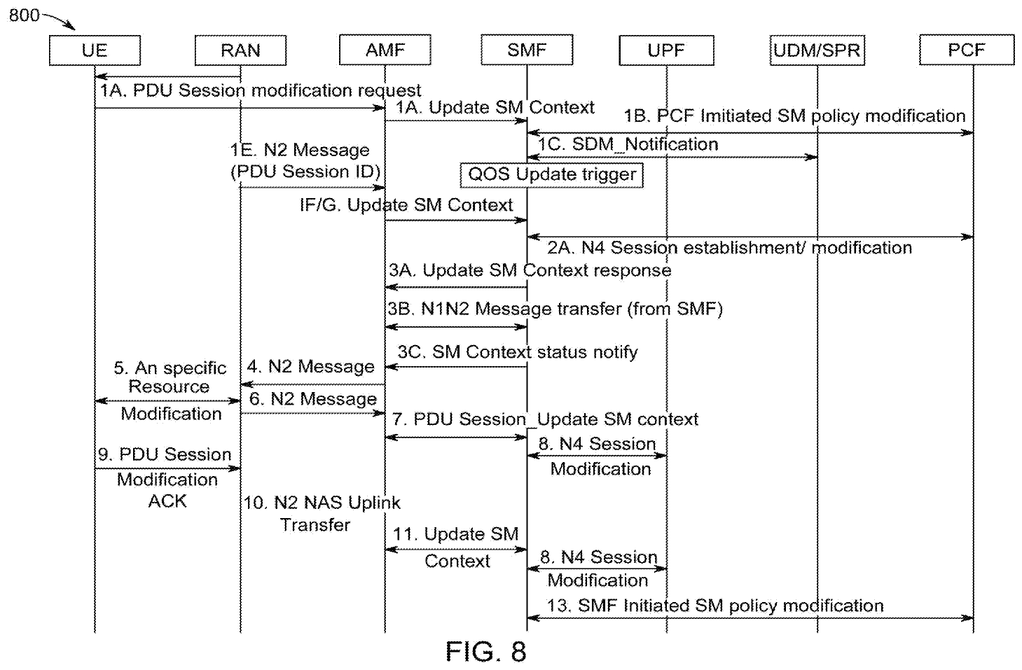

FIG. 7 illustrates SM policy association establishment flows 700, in accordance with an embodiment of the present disclosure.
Sub Step 1—The SMF receives a PDU session establishment request from the UE. The SMF selects the PCF and invokes the Npcf_SMPolicyControl_Create service operation by sending the HTTP POST request to the “SM Policies” resource. Npcf_SMPolicyControl_Create service operation is a request to create an SM Policy Association with the PCF to receive the policy for a PDU session. The request operation provides the SUPI, the PDU session ID, PDU Session Type, DNN, and S-NSSAI, and may provide the GPSI, the Internal Group Identifier, the Access Type (and additional access type, in case of MA PDU session), the IPv4 address or the IPV6 network prefix (if available), the MA PDU session indication and the ATSSS capability, if available, the PEI if received in the SMF, the User Location Information, the UE Time Zone, Serving Network, RAT type, charging information, the Session-AMBR, the DN-AAA authorization profile index if available, one or more framed routes if available, the subscribed default QoS, if available, etc. The request operation also includes a Notification URI to indicate to the PCF where to send a notification when the SM related policies are updated.
Sub Step 2-3—If PCF does not have the subscription data (such as for case when Subscription data was already fetched during AM Policy Session establishment) for the SUPI, DNN and S-NSSAI, the PCF fetches that data from PCF SPR.
Sub Step 4—If the PCF determines that the policy decision depends on the status of the policy counters available at the CHF, and such reporting is not established for the subscriber, the PCF initiates an Initial Spending Limit Report Retrieval. If policy counter status reporting is already established for the subscriber, and the PCF determines that the status of additional policy counters is required, the PCF initiates an Intermediate Spending Limit Report Retrieval.
Sub Step 5—The PCF makes the policy decision to determine the information provided in sub step 8.
Sub Step 6—In the case that the BSF is to be used and that either the IP address/prefix or MAC address is available, the PCF invokes the Nbsf_Management_Register service operation by sending HTTP POST request to create the PDU session binding information for a UE in the BSF. The Nbsf_Management_Register service operation is used to register the binding information for a UE when an IP address is allocated for the PDU Session.
Sub Step 7—The PCF receives an HTTP “201 Created” response from the BSF with the created binding information.
Sub Step 8—The PCF sends an HTTP “201 Created” response to the SMF with the determined policies.
Step 9: If request type is “initial request” and dynamic PCC is deployed and PDU Session Type is IPv4 or IPv6 or IPv4v6, SMF notifies the PCF (if the Policy Control Request Trigger condition is met) with the allocated UE IP address/prefixes. The policy control request trigger condition identifies whether the location of the subscriber is changed or not due to mobility. FIG. 8 illustrates PDU session modification flows 800, in accordance with an embodiment of the present disclosure. This procedure is used when one or several of the QoS parameters exchanged between the UE and the network are modified.
Step 1b: (SMF requested modification) The PCF performs a PCF initiated SM Policy Association Modification procedure to notify SMF about the modification of policies. This may have been triggered by a policy decision or upon AF requests.

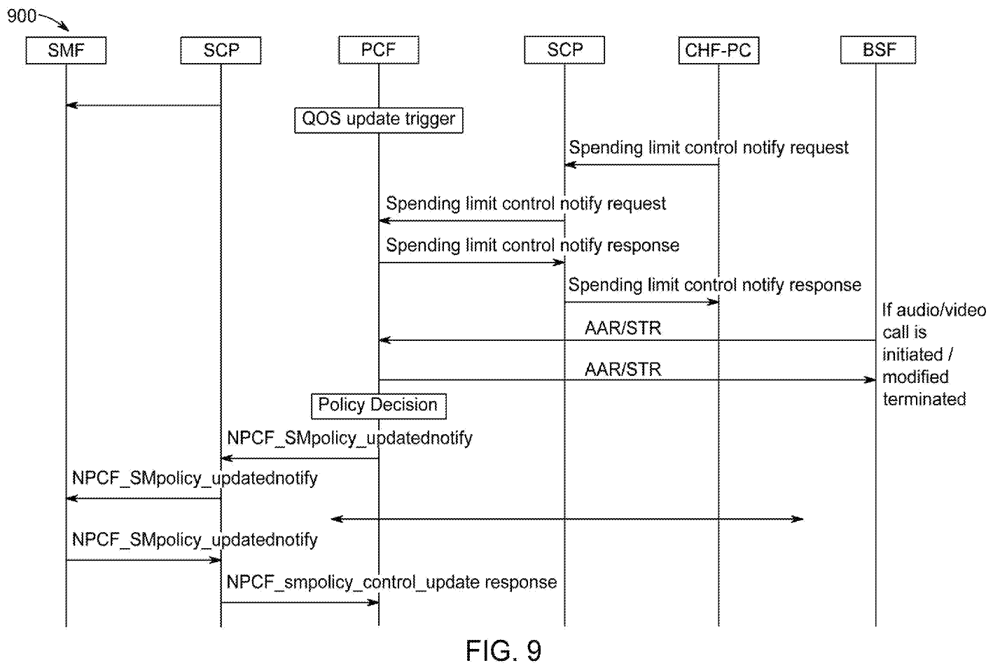

FIG. 9 illustrates PCF initiated session modification flows 900, in accordance with an embodiment of the present disclosure.
Sub Step 1: The PCF receives an internal or external trigger to re-evaluate PCC Rules and policy decision for a PDU Session. In addition, this procedure is triggered by the following cases:
   The UDR/SPR notifies the PCF about a policy subscription change (e.g., change in MPS EPS Priority, MPS Priority Level, MCS Priority Level and/or IMS Signalling Priority, or change in user profile configuration indicating whether supporting application detection and control).
   Spending Limit Trigger: The CHF provides a Spending Limit Report to the PCF.
   Rx Trigger: AAR/STR is received from AF/CSCF via BSF requiring changes in PDUSession.

Sub Step 2: The PCF makes a policy decision (based on sub point 2 or 3 above). The PCF can determine that updated or new policy information need to be sent to the SMF.
Sub Step 4: The PCF invokes the Npcf_SMPolicyControl_UpdateNotify service operation by sending the HTTP POST request with “{notificationUri}/update” as the resource URI to the SMF that has previously subscribed. The request operation provides the PDU session ID and the updated policies.
Sub Step 5: The SMF sends an HTTP “200 OK” to the PCF.

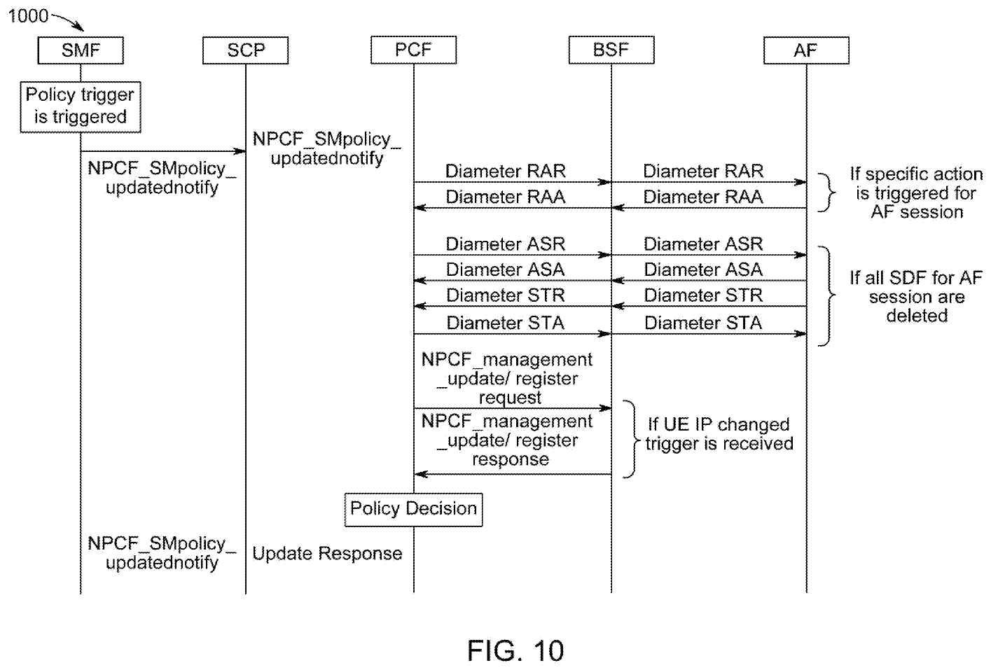

FIG. 10 illustrates SMF initiated session modification flows 1000, in accordance with an embodiment of the present disclosure. This procedure is performed when the SMF observes some policy control trigger condition is met or a PCC rule error is reported.
Sub Step 1: The SMF detects a policy control request trigger condition is met.
Sub Step 2: The SMF invokes the Npcf_SMPolicyControl_Update service operation to the PCF by sending the HTTP POST request to the “Individual SM Policy” resource with information on the conditions that have changed, or a PCC rule error occurs.
Sub Step 3: If the AF requested a notification of the corresponding event, the PCF sends a Diameter RAR with the Specific-Action AVP set to indicate the event that caused the request.
Sub Step 4: The AF replies with a Diameter RAA and may provide updated service information within.
Sub Step 5-6: If all service data flows for an AF session are deleted, the AF session is terminated using Rx interface ASR and STR messages.
Sub Step 7-8: In case SMF has send the information, which have impact on existing UE Binding created at BSF or requires to create a new binding in BSF (like UE IP Change Trigger), PCF shall Register/Update the binding information in BSF (Assuming that Binding Update feature is supported).
Sub Step 9: The PCF makes a policy decision. The PCF may determine that updated or new policy information needs to be sent to the SMF in step 17.
Sub Step 10: The PCF sends an HTTP “200 OK” response to the SMF with updated policy information about the PDU Session determined in step 12.
Step 2: The SMF may need to report some subscribed event to the PCF by performing an SMF initiated SM Policy Association Modification procedure. This step may be skipped if PDU Session Modification procedure is triggered by step 1b or 1d. If dynamic PCC is not deployed, the SMF may apply local policy to decide whether to change the QoS profile.
Step 13: If the SMF interacted with the PCF in step 1b or 2, the SMF notifies the PCF whether the PCC decision could be enforced or not by performing an SMF initiated SM Policy Association Modification procedure. SMF notifies any entity that has subscribed to User Location Information related with PDU Session change.

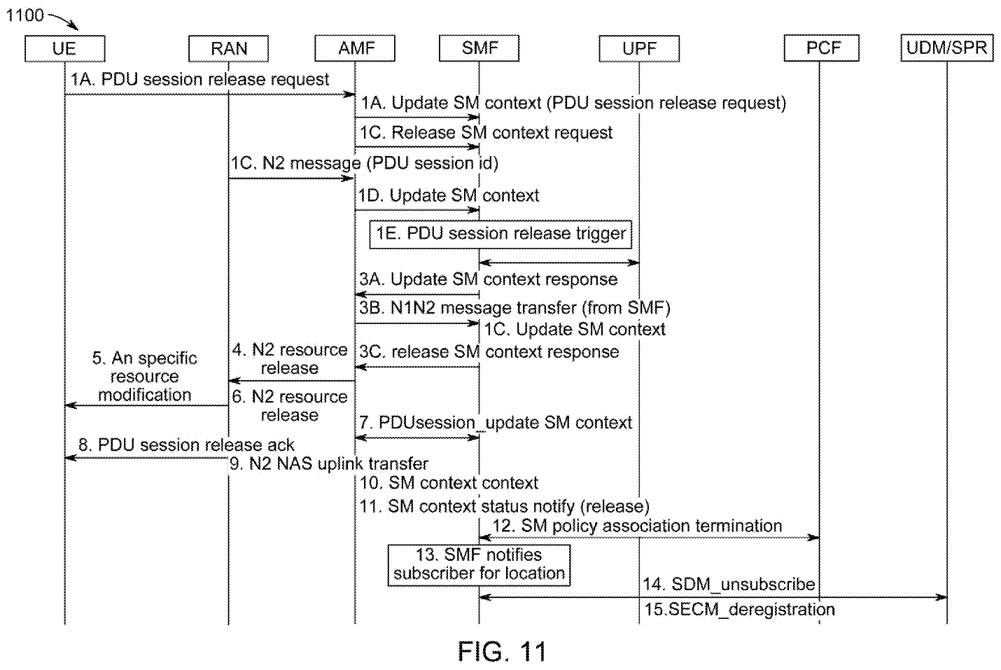

FIG. 11 illustrates PDU session termination flows, in accordance with an embodiment of the present disclosure. The PDU Session release procedure is used to release all the resources associated with a PDU Session, including:
The IP address/Prefixes allocated for an IP-based PDU Session; this may include the release of multiple Prefixes in the case of Multi-homing.
Any UPF resource (including N3/N9/N19 termination) that was used by the PDU Session. For N19 termination, the UPF resource may be released if all the PDU Sessions associated with the 5G VN group are released.
Any access resource that was used by the PDU Session.

The SMF takes care to notify any entity associated with PDU Session: PCF, DN (e.g., when DN authorization has taken place at PDU Session establishment), etc. of a PDU Session Release.
Step 1b: (PDU Session Release initiated by the PCF) The PCF may invoke an SM Policy Association Termination procedure to request the release of the PDU Session. This may be initiated by SMF or PCF. Both procedures are explained in more details below.

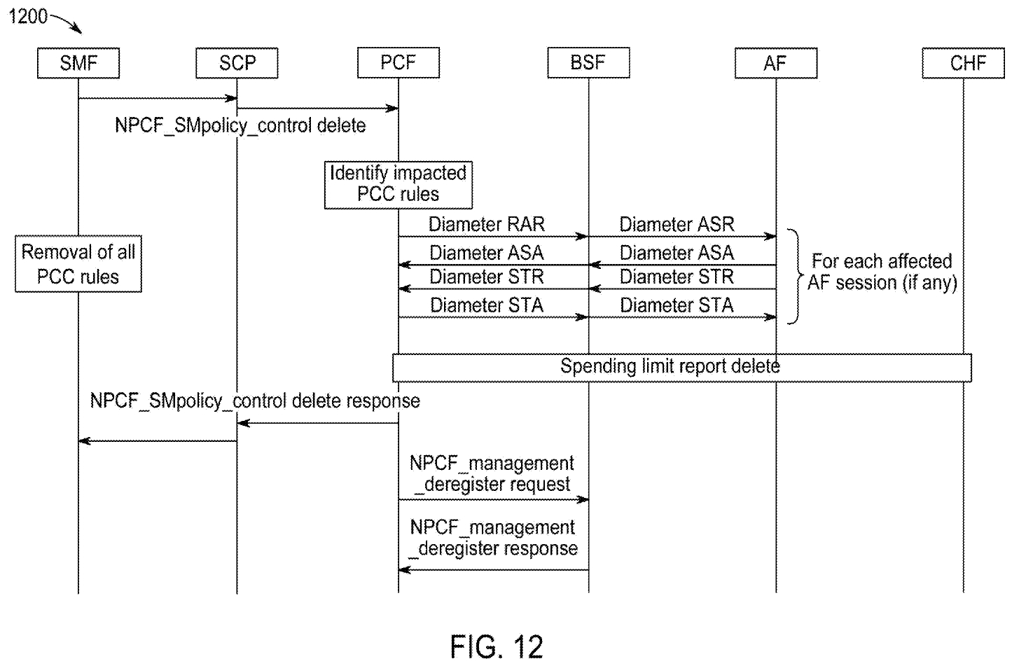

FIG. 12 illustrates SMF initiated SM policy association termination flows, in accordance with an embodiment of the present disclosure. This procedure is performed when the UE requests to terminate a PDU session or based on some internal triggers in the SMF. This procedure concerns both roaming and non-roaming scenarios. In the LBO roaming case, the PCF acts as the V-PCF, and the step 8 shall be skipped. In the home routed roaming case, the PCF acts as the H-PCF, and the H-PCF interacts only with the H-SMF.
Sub Step 1: The SMF invokes the Npcf_SMPolicyControl_Delete service operation by sending the HTTP POST request to the “Individual SM Policy” resource to request the PCF to delete the context of the SM related policy. The Npcf_SMPolicyControl_Delete service operation deletes the SM Policy Association and the associated resources. The request operation may include usage monitoring information (if applicable) and access network information.
Sub Step 2: Upon receipt of Npcf_SMPolicyControl_Delete service operation, the PCF identifies the PCC Rules that require an AF to be notified and removes PCC Rules for the PDUSession.
Sub Step 3: The SMF removes all the PCC Rules which are applied to the PDU session. Sub Step 4: The PCF indicates the session abort to the AF by sending a diameter ASR to the AF.
Sub Step 5: The AF responds by sending a diameter ASA to the PCF.
Sub Step 6: The AF sends a diameter STR to the PCF to indicate that the session has been terminated. The request may include the events to subscribe to.
Sub Step 7: The PCF responds by sending a diameter STA to the AF. If usage thresholds were provided by the AF earlier, and the PCF has usage data that has not yet been reported to the AF, the PCF informs the AF about the resources that have been consumed by the user since the last report. If the SMF in step 1 reports the access network information and if the AF requested the PCF to report access network information in step 6a and/or the RAN-NAS-Cause feature is supported, the PCF informs the AF about the access network information.
Sub Step 8: If this is the last PDU session for this subscriber the Final Spending Limit Report Request is sent. If any existing PDU sessions for this subscriber require policy counter status reporting, the Intermediate Spending Limit Report Request can be sent to alter the list of subscribed policy counters.
Sub Step 9: The PCF removes PCC Rules for the terminated PDU Session and sends an HTTP “204 No Content” response to the SMF.
Sub Step 10: In the case that binding information has been previously registered in the BSF the PCF invokes the Nbsf_Management_Deregister service operation by sending an HTTP DELETE request to the BSF to delete binding information.
Sub Step 11: The PCF receives an HTTP “204 No Content” response from the BSF.
Step 12: If Dynamic PCC applied to this session the SMF invokes an SM Policy Association Termination procedure to delete the PDU Session.

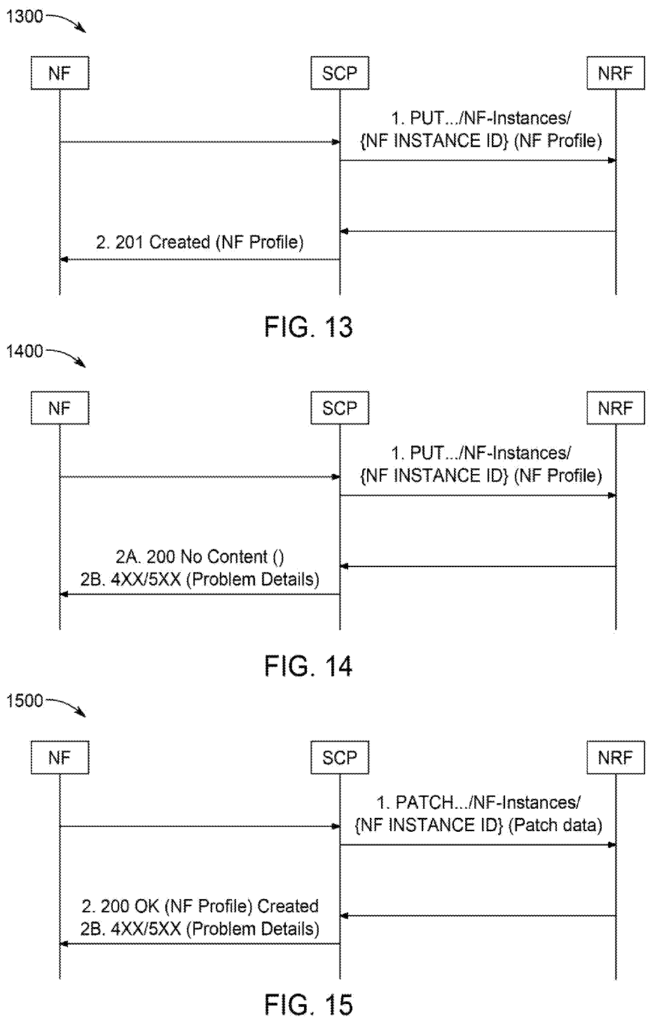

FIG. 13 illustrates a NF registration for registering an NF instance in NRF, in accordance with an embodiment of the present disclosure. As illustrated, an NF Instance registers its NF profile in the NRF. It includes the registration of the General parameters of the NF Instance, together with the list of services exposed by the NF Instance. This service operation is not allowed to be invoked from an NRF in a different PLMN.
Step 1: The NF Service Consumer shall send a PUT request to the resource URI representing the NF Instance. The URI is determined by the NF Instance. The variable {nfInstanceID} represents an identifier, provided by the NF Service Consumer that shall be globally unique inside the PLMN of the NRF where the NF is being registered. The format of the NF Instance ID shall be a Universally Unique Identifier (UUID) version 4, as described in IETF RFC 4122 [18]. EXAMPLE: UUID version 4: “4947a69a-f61b-4bc1-b9da-47c9c5d14b64”
The payload body of the PUT request shall contain a representation of the NF Instance to be created.
Step 2: On success, “201 Created” shall be returned, the payload body of the PUT response shall contain the representation of the created resource and the “Location” header shall contain the URI of the created resource. Additionally, the NRF returns a “heart-beat timer” containing the number of seconds expected between two consecutive heart-beat messages from an NF Instance to the NRF. The representation of the created resource may be a complete NF Profile or a NF Profile just including the mandatory attributes of the NF Profile and the attributes which the NRF added or changed.

If the registration of the NF instance fails at the NRF due to errors in the encoding of the NFProfile JSON object, the NRF shall return “400 Bad Request” status code with the ProblemDetails IE providing details of the error.

If the registration of the NF instance fails at the NRF due to NRF internal errors, the NRF shall return “500 Internal Server Error” status code with the ProblemDetails IE providing details of the error.

During the registration of a Network Function instance with a custom NF type, the NF instance may provide NF-specific data (in the “customInfo” attribute), that shall be stored by the NRF as part of the NF profile of the NF instance.

The NRF shall accept the registration of NF Instances containing Vendor-Specific attributes, and therefore, it shall accept NF Profiles containing attributes whose type may be unknown to the NRF, and those attributes shall be stored as part of the NF's profile data in NRF.

FIG. 14 illustrates a NF update involving complete replacement, in accordance with an embodiment of the present disclosure. It allows an NF Instance to replace, or update partially, the parameters of its NF profile (including the parameters of the associated services) in the NRF; it also allows to add or delete individual services offered by the NF Instance. This service operation is not allowed to be invoked from an NRF in a different PLMN.

To perform a complete replacement of the NF Profile of a given NF Instance, the NF Service Consumer shall issue an HTTP PUT request.
Step 1: The NF Service Consumer shall send a PUT request to the resource URI representing the NF Instance. The payload body of the PUT request shall contain a representation of the NF Instance to be completely replaced in the NRF.
Step 2a: On success, “200 OK” shall be returned, the payload body of the PUT response shall contain the representation of the replaced resource. The representation of the replaced resource may be a complete NF Profile or a NF Profile just including the mandatory attributes of the NF Profile and the attributes which the NRF added or changed.
Step 2b: If the update of the NF instance fails at the NRF due to errors in the encoding of the NFProfile JSON object, the NRF shall return “400 Bad Request” status code with the ProblemDetails IE providing details of the error. If the update of the NF instance fails at the NRF due to NRF internal errors, the NRF shall return “500 Internal Server Error” status code with the ProblemDetails IE providing details of the error.

FIG. 15 illustrates a NF update 1500 involving partial replacement, in accordance with an embodiment of the present disclosure. Partial update procedure PCF is not supported except for Heartbeat procedure. To perform a partial update of the NF Profile of a given NF Instance, the NF Service Consumer shall issue an HTTP PATCH request. This partial update shall be used to add/delete/replace individual parameters of the NF Instance, and also to add/delete/replace any of the services (and their parameters) offered by the NF Instance.
Step 1: The NF Service Consumer shall send a PATCH request to the resource URI representing the NF Instance. The payload body of the PATCH request shall contain the list of operations (add/delete/replace) to be applied to the NF Profile of the NF Instance; these operations may be directed to individual parameters of the NF Profile or to the list of services (and their parameters) offered by the NF Instances. In order to leave the NF Profile in a consistent state, all the operations specified by the PATCH request body shall be executed atomically.
Step 2a: On success, “200 OK” shall be returned, the payload body of the PATCH response shall contain the representation of the replaced resource.
Step 2b: If the NF Instance, identified by the “nfInstanceID,” is not found in the list of registered NF Instances in the NRF's database, the NRF shall return “404 Not Found” status code with the ProblemDetails IE providing details of the error.

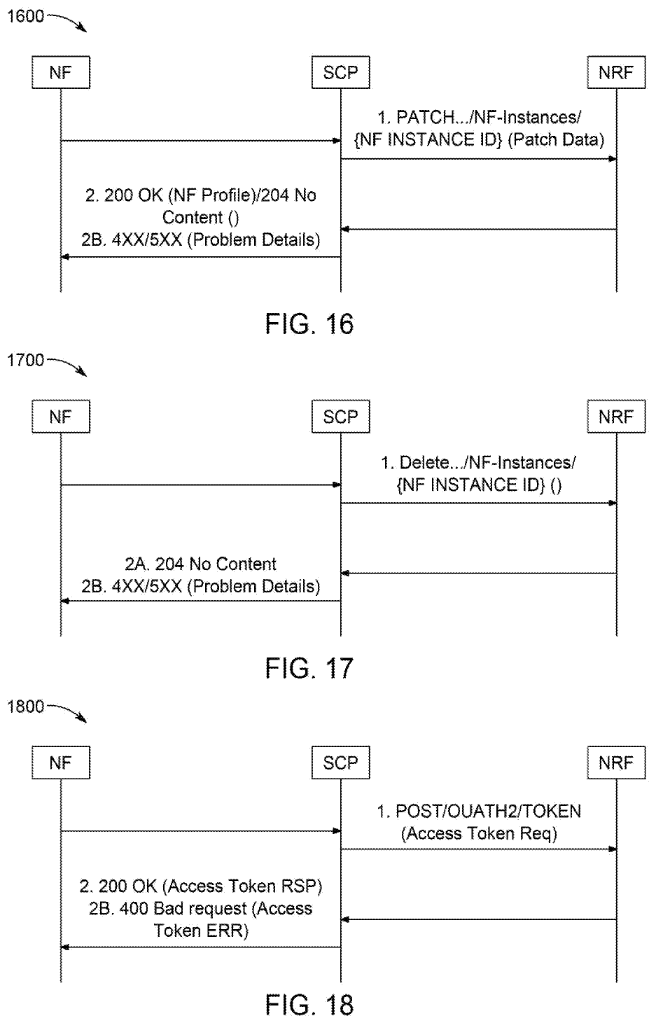

FIG. 16 illustrates a NF Heart-Beat 1600, in accordance with an embodiment of the present disclosure. Each NF that has previously registered in NRF shall contact the NRF periodically (heartbeat), by invoking the NFUpdate service operation, in order to show that the NF is still operative. The time interval at which the NRF shall be contacted is deployment-specific, and it is returned by the NRF to the NF Service Consumer as a result of a successful registration. When the NRF detects that a given NF has not updated its profile for a configurable amount of time (longer than the heart-beat interval), the NRF changes the status of the NF to SUSPENDED and considers that the NF and its services can no longer be discovered by other NFs via the NFDiscovery service. The NRF notifies NFs subscribed to receiving notifications of changes of the NF Profile that the NF status has been changed to SUSPENDED.
Step 1: The NF Service Consumer shall send a PATCH request to the resource URI representing the NF Instance. The payload body of the PATCH request shall contain a “replace” operation on the “nfStatus” attribute of the NF Profile of the NF Instance and set it to the value “REGISTERED” or “UNDISCOVERABLE.”

In addition, the NF Service Consumer may also provide the load information of the NF, and/or the load information of the NF associated NF services. The provision of such load information may be limited by this NF via appropriate configuration (e.g., granularity threshold) in order to avoid notifying minor load changes.
Step 2a: On success, the NRF should return “204 No Content”; the NRF may also answer with “200 OK” along with the full NF Profile, e.g., in cases where the NRF determines that the NF Profile has changed significantly since the last heart-beat and wants to send the new profile to the NF Service Consumer.
Step 2b: If the NF Instance, identified by the “nfInstanceID,” is not found in the list of registered NF Instances in the NRF's database, the NRF shall return “404 Not Found” status code with the ProblemDetails IE providing details of the error.

FIG. 17 illustrates a NRF NFderegister 1700, in accordance with an embodiment of the present disclosure. This service operation removes the profile of a NF previously registered in the NRF. It is executed by deleting a given resource identified by a “NF Instance ID.” The operation is invoked by issuing a DELETE request on the URI representing the specific NF Instance.
Step 1: The NF Service Consumer shall send a DELETE request to the resource URI representing the NF Instance (NRF). The request body shall be empty.
Step 2a: On success, “204 No Content” shall be returned. The response body shall be empty.
Step 2b: If the NF Instance, identified by the “nfInstanceID,” is not found in the list of registered NF Instances in the NRF's database, the NRF shall return “404 Not Found” status code with the ProblemDetails IE providing details of the error.

FIG. 18 illustrates a NF AccessToken request 1800, in accordance with an embodiment of the present disclosure. This service operation is used by an NF Service Consumer to request an OAuth2 access token from the authorization server (NRF).
Step 1: The NF Service Consumer shall send a POST request to the “Token Endpoint,”
The “Token Endpoint” URI shall be: {nrfApiRoot}/oauth2/token.

The OAuth 2.0 Access Token Request includes in the body of the HTTP POST request shall contain:
An OAuth2 grant type set to “client_credentials”;
The “scope” parameter indicating the names of the NF Services that the NF Service Consumer is trying to access (i.e., the expected NF service names);
The NF Instance Id of the NF Service Consumer requesting the OAuth2.0 access token, if this is an access token request for a specific NF Service Producer;
NF type of the NF Service Consumer, if this is an access token request not for a specific NF Service Producer;
NF type of the expected NF Service Producer, if this is an access token request for a specific NF Service Producer;
The NF Instance Id of the expected NF Service Producer, if this is an access token request for a specific NF Service Producer;
Home and Serving PLMN IDs, if this is an access token request for use in roaming scenarios.
No Username/Password is needed for standard get AccessToken service operation rather Secret Key can be configured at NRF per NFType (Key needs to be preshared between NF and NRF using means not in scope of this document).
Step 2: On success, “200 OK” shall be returned, the payload body of the POST response shall contain the requested access token and the token type set to value “Bearer”.

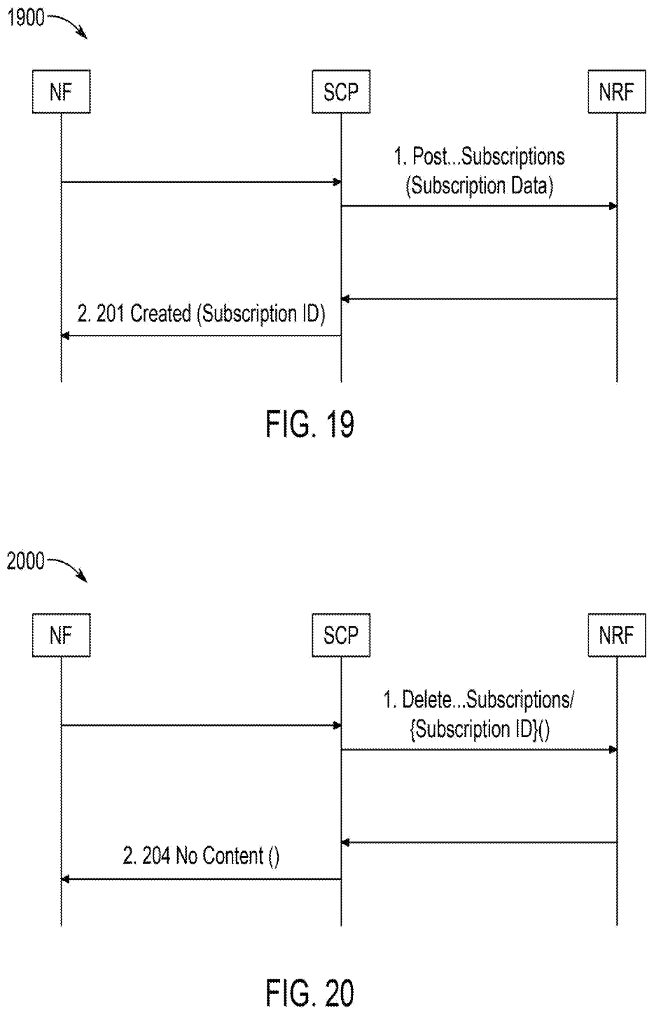

FIG. 19 illustrates a NF StatusSubscribe 1900, in accordance with an embodiment of the present disclosure. NFStatusSubscribe allows an NF Instance to subscribe to changes on the status of NF Instances registered in NRF. This service operation can be invoked by an NF Instance in a different PLMN (via the local NRF in that PLMN).
Step 1: The NF Service Consumer shall send a POST request to the resource URI representing the “subscriptions” collection resource. The request body shall include the data indicating the type of notifications that the NF Service Consumer is interested in receiving; it also contains a call back URI, where the NF Service Consumer shall be prepared to receive the actual notification from the NRF and it may contain a validity time, suggested by the NF Service Consumer, representing the time span during which the subscription is desired to be kept active. The subscription request may also include additional parameters indicating the list of attributes in the NF Profile to be monitored, in order to determine whether a notification from NRF should be sent, or not, when any of those attributes is changed in the profile.
Step 2a: On success, “201 Created” shall be returned. The response shall contain the data related to the created subscription, including the validity time, as determined by the NRF, after which the subscription becomes invalid. Once the subscription expires, if the NF Service Consumer wants to keep receiving status notifications, it shall create a new subscription in the NRF.
Step 2b: If the creation of the subscription fails at the NRF due to errors in the SubscriptionData JSON object in the request body, the NRF shall return “400 Bad Request” status code with the ProblemDetails IE providing details of the error.
If the creation of the subscription fails at the NRF due to NRF internal errors, the NRF shall return “500 Internal Server Error” status code with the ProblemDetails IE providing details of the error.

FIG. 20 illustrates a NF StatusUnSubscribe 2000, in accordance with an embodiment of the present disclosure. The NFStatusUnSubscribe allows an NF Instance to unsubscribe to changes on the status of NF Instances Registered in NRF. This service operation can be invoked by an NF Instance in a different PLMN (via the local NRF in that PLMN).

The NF Service Consumer shall send a DELETE request to the resource URI representing the individual subscription. The request body shall be empty.

On success, “204 No Content” shall be returned. The response body shall be empty. If the subscription, identified by the “subscriptionID,” is not found in the list of active subscriptions in the NRF's database, the NRF shall return “404 Not Found” status code with the ProblemDetails IE providing details of the error.

FIG. 21 illustrates a NF StatusNotify 2100, in accordance with an embodiment of the present disclosure. The NFStatusNotify allows the NRF to notify subscribed NF Instances of changes on the status of NF Instances. This service operation can be invoked by an NF Instance in a different PLMN (via the local NRF in that PLMN).
Step 1: The NRF shall send a POST request to the callback URI.
For notifications of newly registered NF Instances, the request body shall include the data associated to the newly registered NF, and its services, according to the criteria indicated by the NF Service Consumer during the subscription operation. These data shall contain the NFInstanceID of the NF Instance, an indication of the event being notified (“registration”), and the new profile data (including, among others, the services offered by the NF Instance).
For notifications of changes of the profile of a NF Instance, the request body shall include the NFInstancceID of the NF Instance whose profile was changed, an indication of the event being notified (“profile change”), and the new profile data.
For notifications of deregistration of the NF Instance from NRF, the request body shall include the NFInstanceID of the deregistered NF Instance, and an indication of the event being notified (“deregistration”).
Step 2: On success, “204 No content” shall be returned by the NF Service Consumer. If the NF Service Consumer does not consider the “nfStatusNotificationUri” as a valid notification URI (e.g., because the URI does not belong to any of the existing subscriptions created by the NF Service Consumer in the NRF), the NF Service Consumer shall return “404 Not Found” status code with the ProblemDetails.

The Nnrf_NFDiscovery service allows a NF or SCP Instance to discover other NF Instances with the potential services they offer, by querying the local NRF. It also allows an NRF in a PLMN to re-issue a discovery request towards an NRF in another PLMN (e.g., the HPLMN of a certain UE). It provides to the NF service consumer or SCP the profile (including IP address or FQDN) of the NF Instance or NF Services matching certain input criteria.

Before a service consumer invokes this service operation, it shall consider if it is possible to reuse the results from a previous searching (service discovery). The service consumer should reuse the previous result if input query parameters in the new service discovery request are the same as used for the previous search and the validity period of the result is not expired.

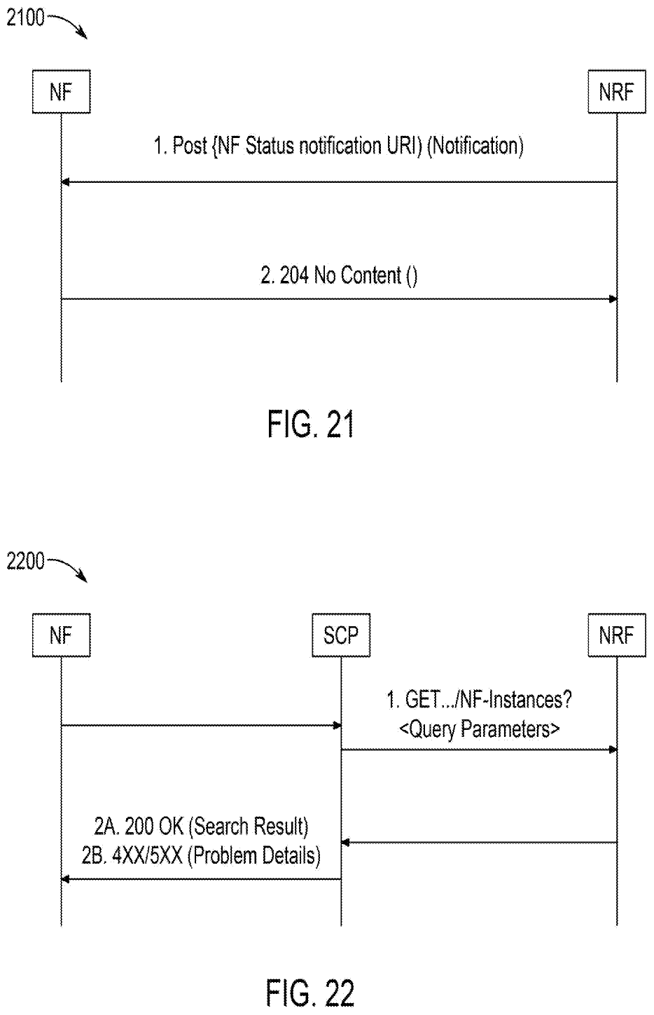

The service consumer may consider reusing the previous result if the attributes as required for the new query are also part of the NF profile of the candidates NFs from a previous query. In such a case, when the results of a previous query are reused, the service consumer needs to consider that the results, e.g., in terms of the number of discovered NFS, can be different than the potential results obtained after performing a new query. FIG. 22 illustrates a NF Discovery Request, in accordance with an embodiment of the present disclosure. As disclosed, at
Step 1: The NF Service Consumer shall send an HTTP GET request to the resource URI “nf-instances” collection resource. The input filter criteria for the discovery request shall be included in query parameters.
Step 2a: On success, “200 OK” shall be returned. The response body shall contain a validity period, during which the search result can be cached by the NF Service Consumer, and an array of NF Profile objects, that satisfy the search filter criteria (e.g., all NF Instances offering a certain NF Service name).
Step 2b: If the NF Service Consumer is not allowed to discover the NF services for the requested NF type provided in the query parameters, the NRF shall return “403 Forbidden” response.

If the discovery request fails at the NRF due to errors in the input data in the URI query parameters, the NRF shall return “400 Bad Request” status code with the ProblemDetails IE providing details of the error. If the discovery request fails at the NRF due to NRF internal errors, the NRF shall return “500 Internal Server Error” status code with the ProblemDetails IE providing details of the error. The 500 Internal Server error could be caused by an error during the execution of any policy within Edge or by an error on the target/backend server. The HTTP status code 500 is a generic error response.

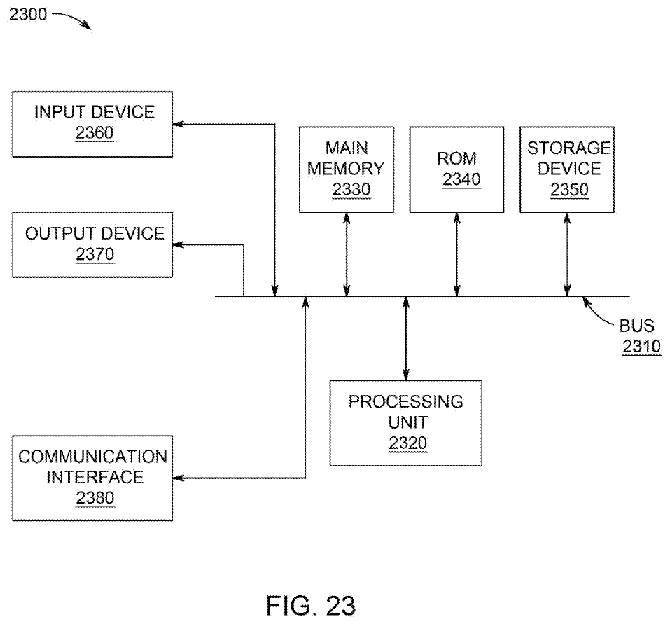

FIG. 23 is a diagram that depicts exemplary computer system 2300 in which or with which embodiments of the present disclosure may be implemented. As shown in FIG. 23, the computer system 2300 may include a bus 2310, a processing unit 2320, a main memory 2330, a read only memory (ROM) 2340, a storage device 2350, an input device 2360, an output device 2370, and a communication interface 2380. Bus 2310 may include a path that permits communication among the other components of the computer system 2300.

Processing unit 2320 may include one or more processors or microprocessors which may interpret and execute stored instructions associated with one or more processes, or processing logic that implements the one or more processes. For example, processing unit 2320 may include, but is not limited to, programmable logic such as Field Programmable Gate Arrays (FPGAs) or accelerators. Processing unit 2320 may include software, hardware, or a combination of software and hardware for executing the processes described herein. Main memory 2330 may include a random-access memory (RAM) or another type of dynamic storage device that may store information and, in some implementations, instructions for execution by processing unit 2320. ROM 2340 may include a ROM device or another type of static storage device (e.g., Electrically Erasable Programmable ROM (EEPROM)) that may store static information and, in some implementations, instructions for use by processing unit 2320. Storage device 2350 may include a magnetic, optical, and/or solid state (e.g., flash drive) recording medium and its corresponding drive. Main memory 2330, ROM 2340 and storage device 2350 may each be referred to herein as a “non-transitory computer-readable medium” or a “non-transitory storage medium.” The process/methods set forth herein can be implemented as instructions that are stored in main memory 2330, ROM 2340 and/or storage device 2350 for execution by processing unit 2320.

Input device 2360 may include one or more devices that permit an operator to input information to computer system 2300, such as, for example, a keypad or a keyboard, a display with a touch sensitive panel, voice recognition and/or biometric mechanisms, etc. Output device 2370 may include one or more devices that output information to the operator, including a display, a speaker, etc. Input device 2360 and output device 2370 may, in some implementations, be implemented as a user interface (UI) that displays UI information and which receives user input via the UI. Communication interface 2380 may include one or more transceivers that enable computer system 2300 to communicate with other devices and/or systems. For example, communication interface 2380 may include one or more wired or wireless transceivers for communicating via network 2330.

The computer system 2300 may perform certain operations or processes, as may be described herein. The computer system 2300 may perform these operations in response to processing unit 2320 executing software instructions contained in a computer-readable medium, such as memory 2330. A computer-readable medium may be defined as a physical or logical memory device. A logical memory device may include memory space within a single physical memory device or spread across multiple physical memory devices. The software instructions may be read into main memory 2330 from another computer-readable medium, such as storage device 2350, or from another device via communication interface 2380. The software instructions contained in main memory 2330 may cause processing unit 2320 to perform the operations or processes, as described herein. Alternatively, hardwired circuitry (e.g., logic hardware) may be used in place of, or in combination with, software instructions to implement the operations or processes, as described herein. Thus, exemplary implementations are not limited to any specific combination of hardware circuitry and software.

The configuration of components of computer system 2300 illustrated in FIG. 23 is for illustrative purposes only. Other configurations may be implemented. Therefore, computer system 2300 may include additional, fewer and/or different components, arranged in a different configuration, than depicted in FIG. 23.

In an exemplary embodiment, the present invention discloses a policy control function (PCF) to provide a plurality of policy rules for control plane functions in a network. The PCF is configured to receive, by an access management function (AMF), at least one registration request message from at least one terminal device (user equipment). The PCF is configured to select, by the AMF, a PCF currently serving the at least one terminal device based on the received at least one registration request. The PCF is configured to create at least one policy rule for a subscriber in real-time based on at least one subscriber's profile and a plurality of parameters and send, to the AMF, a response message comprising the at least one created policy rule.

In some embodiments, the plurality of parameters comprises one or more of: subscription permanent identifier (SUPI), network slice selection assistance information (NSSAI), service area restrictions, RAT frequency selection priority (RFSP) index, generic public subscription identifier (GPSI), and a list of internal group identifiers.

In an aspect, the internal group identifiers include other parameters like location and tracking area identity of the subscriber. Further, the service area restrictions include code assigned to specific area for specific services like barring etc.

In some embodiments, the at least one subscriber's profile associated with the at least one terminal device is retrieved from a subscriber profile repository (SPR).

In some embodiments, the PCF comprising a system management point (SMP), a fault, configuration, accounting, performance (FCAP) manager, an availability (HA) state manager, a session database layer (SDL) and the SPR.

In some embodiments, the PCF is further configured to integrate with a plurality of network functions via a service communication proxy (SCP) using a hypertext transfer protocol 2 (HTTP2) based interface.

In some embodiments, the at least one policy includes a plurality of service area restrictions, a RAT frequency selection priority (RFSP) index, at least one policy control request trigger condition and a related policy. The policy control request trigger condition identifies whether the location of the subscriber is changed or not due to mobility.

In some embodiments, the AMF deploys the at least one policy rule to the at least one terminal device and provision the RFSP index and the plurality of service area restrictions to the network.

In some embodiments, during relocation of the AMF, the PCF is selected based on a PCF ID received by a new AMF from a source AMF.

In some embodiments, the created at least policy rule is based on a specific domain name network (DNN) and a policy rule engine. The DNN includes checking if the subscriber is connected through 5G or 4G network etc. Further, the policy rule engine defines the conditions such as install or remove applications if a particular condition is met. A typical policy rule engine consists of a policy repository, policy evaluator, and policy administration interface. The advantages of using a policy engine include centralized policy management, flexibility in defining and updating policies, and improved security through consistent rule enforcement and detailed audit logs.

In an exemplary embodiment, the present invention discloses a network comprising a policy control function (PCF) to provide a plurality of policy rules for control plane functions of the network. The PCF is configured to receive, by an access management function (AMF), at least one registration request message from at least one terminal device. The PCF is configured to select, by the AMF, a PCF currently serving the at least one terminal device based on the received at least one registration request. The PCF is configured to create at least one policy rule for the subscriber in real-time based on at least one subscriber's profile and a plurality of parameters and send, to the AMF, a response message comprising the at least one created policy rule.

In an exemplary embodiment, the present invention discloses a method for providing a plurality of policy rules for control plane functions of a network comprising a policy control function (PCF). The method comprising receiving, by an access management function (AMF), at least one registration request message from at least one terminal device. The method comprising selecting, by the AMF, a PCF currently serving the at least one terminal device based on the received at least one registration request. The method comprising creating at least one policy rule for the subscriber in real-time based on at least one subscriber's profile and a plurality of parameters and sending, to the AMF, a response message comprising the at least one created policy rule.

In some embodiments, the plurality of parameters comprises one or more of: subscription permanent identifier (SUPI), network slice selection assistance information (NSSAI), service area restrictions, RAT frequency selection priority (RFSP) index, generic public subscription identifier (GPSI), and a list of internal group identifiers.

In some embodiments, the at least one subscriber's profile associated with the at least one terminal device is retrieved from a subscriber profile repository (SPR).

In some embodiments, the PCF comprising a system management point (SMP), a fault, configuration, accounting, performance (FCAP) manager, an availability (HA) state manager, a session database layer (SDL) and the SPR.

In some embodiments, the PCF is further configured to integrate with a plurality of network functions via a service communication proxy (SCP) using a hypertext transfer protocol 2 (HTTP2) based interface.

In some embodiments, the at least one policy includes a plurality of service area restrictions, a RAT frequency selection priority (RFSP) index, at least one policy control request trigger condition and a related policy.

In some embodiments, the AMF deploys the at least one policy rule to the at least one terminal device and provision the RFSP index and the plurality of service area restrictions to the network.

In some embodiments, during relocation of the AMF, the PCF is selected based on a PCF ID received by a new AMF from a source AMF.

In some embodiments, the created at least policy rule is based on a specific domain name network (DNN) and a policy rule engine. The DNN includes checking if the subscriber is connected through 5G or 4G network etc. Further, the policy rule engine defines the conditions such as install or remove applications if a particular condition is met. A typical policy rule engine consists of a policy repository, policy evaluator, and policy administration interface. The advantages of using a policy engine include centralized policy management, flexibility in defining and updating policies, and improved security through consistent rule enforcement and detailed audit logs.

The present disclosure is configured to disclose a PCF architecture that provides policy rules for control plane functions such as network slicing, roaming and mobility management. The PCF in a 5G core network provides a network agnostic solution (wireline and wireless) and enables multi-dimensional approach which helps in creating a lucrative and innovative platform for operators. This can also be integrated with different platforms like billing, rating, charging, and subscriber database or deploy as a standalone entity. The disclosed PCF design is having high resilience and scalability. The present disclosure provides the PCF such that there is no single point of failure which includes node level redundancy, network redundancy and geo-redundancy. The present disclosure provides minimal latency and packet loss under load condition in a wireless network. The present disclosure is configured to be employed in a communication system that requires an improved PCF architecture.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure supports performing functionalities of a Policy Control Function (PCF).

The present disclosure provides the PCF that stores binding information for a particular Protocol Data Unit (PDU) session and enables discovery of binding information.

The present disclosure provides a PCF design having high resilience and scalability.

The present disclosure provides the PCF such that there is no single point of failure which includes node level redundancy, network redundancy and geo-redundancy.

The present disclosure provides minimal latency and packet loss under load condition in a wireless network.

The present disclosure integrates the PCF with other network functions via HyperText Transfer Protocol 2 (HTTP2) based interfaces both directly and via a Service Communication Proxy (SCP).

The present disclosure provides a separate Session Database Layer (SDL) to provide session data across multiple sites for geo-redundancy.

The present disclosure deploys the PCF in active, hot standby and spare manner across the wireless network.

The present disclosure enables load distribution of messages by the SCP on multiple PCF blades based on subscriber's identities i.e., Subscription Permanent Identifier (SUPI) ranges.

The present disclosure enables providing a separate SDL that provides session data across sites for geo-redundancy.

The present disclosure provides an embedded SPR with the PCF.

The present disclosure provides a centralized health check functionality.

The present disclosure provides overload control mechanisms for stable functioning during sudden bursts of traffic.

We claim:

1. A policy control function (PCF) to provide a plurality of policy rules for control plane functions in a network, the PCF is configured to:
receive, by an access management function (AMF), at least one registration request message from at least one terminal device;
select, by the AMF, a PCF currently serving the at least one terminal device based on the received at least one registration request;
create at least one policy rule for a subscriber in real-time based on at least one subscriber's profile and a plurality of parameters; and
send, to the AMF, a response message comprising the at least one created policyrule.

2. The PCF as claimed in claim 1, wherein the plurality of parameters comprises one or more of: subscription permanent identifier (SUPI), network slice selection assistance information (NSSAI), service area restrictions, RAT frequency selection priority (RFSP) index, generic public subscription identifier (GPSI), and a list of internal groupidentifiers.

3. The PCF as claimed in claim 1, wherein the at least one subscriber's profile associated with the at least one terminal device is retrieved from a subscriber profile repository (SPR).

4. The PCF as claimed in claim 1, comprising a system management point (SMP), a fault, configuration, accounting, performance (FCAP) manager, an availability (HA) state manager, a session database layer (SDL) and the SPR.

5. The PCF as claimed in claim 1, wherein the PCF is further configured to integrate with a plurality of network functions via a service communication proxy (SCP) using a hypertext transfer protocol 2 (HTTP2) based interface.

6. The PCF as claimed in claim 1, wherein the at least one policy includes a plurality of service area restrictions, a RAT frequency selection priority (RFSP) index, at least one policy control request trigger condition and a related policy.

7. The PCF as claimed in claim 1, wherein the AMF deploys the at least one policy rule to the at least one terminal device and provision the RFSP index and the plurality of service area restrictions to the network.

8. The PCF as claimed in claim 1, wherein during relocation of the AMF, the PCF is selected based on a PCF ID received by a new AMF from a source AMF.

9. The PCF as claimed in claim 1, wherein the created at least policy rule is based on a specific domain name network (DNN) and a policy rule engine.

10. A network comprising a policy control function (PCF) to provide a plurality of policy rules for control plane functions in the network, wherein the PCF is configured to:
receive, by an access management function (AMF), at least one registration request message from at least one terminal device;
select, by the AMF, a PCF currently serving the at least one terminal device based on the received at least one registration request;
create at least one policy rule for a subscriber in real-time based on at least one subscriber's profile and a plurality of parameters; and
send, to the AMF, a response message comprising the at least one created policyrule.

11. A method for providing a plurality of policy rules for control plane functions in a network comprising a policy control function (PCF), the method comprising:
receiving, by an access management function (AMF), at least one registration request message from at least one terminal device;
selecting, by the AMF, a PCF currently serving the at least one terminal device based on the received at least one registration request;
creating at least one policy rule for a subscriber in real-time based on at least one subscriber's profile and a plurality of parameters; and
sending, to the AMF, a response message comprising the at least one created policy rule.

12. The method as claimed in claim 11, wherein the plurality of parameters comprises one or more of: subscription permanent identifier (SUPI), network slice selection assistance information (NSSAI), service area restrictions, RAT frequency selection priority (RFSP) index, generic public subscription identifier (GPSI), and a list of internal groupidentifiers.

13. The method as claimed in claim 11, wherein the at least one subscriber's profile associated with the at least one terminal device is retrieved from a subscriber profile repository (SPR).

14. The method as claimed in claim 11, wherein the PCF comprising a system management point (SMP), a fault, configuration, accounting, performance (FCAP) manager, an availability (HA) state manager, a session database layer (SDL) and the SPR.

15. The method as claimed in claim 11, wherein the PCF is further configured to integrate with a plurality of network functions via a service communication proxy (SCP) using a hypertext transfer protocol 2 (HTTP2) based interface.

16. The method as claimed in claim 11, wherein the at least one policy includes a plurality of service area restrictions, a RAT frequency selection priority (RFSP) index, at least one policy control request trigger condition and a related policy.

17. The method as claimed in claim 11, wherein the AMF deploys the at least one policy rule to the at least one terminal device and provision the RFSP index and the plurality of service area restrictions to the network.

18. The method as claimed in claim 11, wherein during relocation of the AMF, the PCF is selected based on a PCF ID received by a new AMF from a source AMF.

19. The method as claimed in claim 11, wherein the created at least policy rule is based on a specific domain name network (DNN) and a policy rule engine.

20. A computer program product comprising a non-transitory computer-readable medium comprising instructions that, when executed by one or more processors, cause the one or more processors to perform a method for providing a plurality of policy rules for control plane functions in a network comprising network comprising a policy control function (PCF), the method comprising:
receiving, by an access management function (AMF), at least one registration request message from at least one terminal device;
selecting, by the AMF, a PCF currently serving the at least one terminal device based on the received at least one registration request;
creating at least one policy rule for a subscriber in real-time based on at least one subscriber's profile and a plurality of parameters; and
sending, to the AMF, a response message comprising the at least one created policy rule.
